(19) United States
(12) Patent Application Publication
(10) Pub. No.: US 2025/0185666 A1
(43) Pub. Date: Jun. 12, 2025

(54) Root-Targeted Delivery of Agrochemicals using Natural Microbial Carriers

(71) Applicant: University of Connecticut, Farmington, CT (US)

(72) Inventors: Leslie McCabe SHOR, Coventry, CT (US); Christopher James HAWXHURST, Andover, CT (US); Daniel GAGE, Columbia, CT (US); Daniel KIRK, Indianapolis, IN (US)

(21) Appl. No.: 18/977,711

(22) Filed: Dec. 11, 2024

Related U.S. Application Data
(60) Provisional application No. 63/608,440, filed on Dec. 11, 2023.

(51) Int. Cl. A01N 63/10; A01N 25/26; A01N 43/56; A01N 63/20; A01P 3/00; A01P 5/00; A01P 7/04

(52) U.S. Cl. CPC A01N 63/10; A01N 25/26; A01N 43/56; A01N 63/20; A01P 3/00; A01P 5/00; A01P 7/04

(57) ABSTRACT

Agrochemical compositions including an agriculturally suitable carrier; one or more encysted or sporulated protozoa (protist); and an agricultural payload including an agrochemical with or without a food source for protozoa such as a agriculturally nonbeneficial bacteria are provided. Also provided is a modified plant seed, and methods for improving plant growth, reducing plant loss to pests, and controlling or eliminating pest infestation of a crop plant, each including use of the described agrochemical compositions.

### CROSS-REFERENCE TO RELATED APPLICATIONS

This application claims the benefit of U.S. Provisional Patent Application No. 63/608,440, filed Dec. 11, 2023, which is incorporated by reference herein in its entirety.

### STATEMENT REGARDING FEDERALLY SPONSORED RESEARCH

This invention was made with government support under 1605816 awarded by the National Science Foundation. The government has certain rights in the invention.

### BACKGROUND

Chemicals including herbicides, fungicides, insecticides, and nematicides are commonly used in agriculture. While herbicides are commonly applied as a foliar spray, many insecticides, fungicides, and nematicides require soil application and act at, or are absorbed by, the roots following transport through the soil via water. Some agrochemicals suffer from poor soil transmission, an inability to target delivery to vulnerable, actively growing roots, and health, safety, and environmental concerns from high application rates. Further, due to their high specific cost, bulk application of agrochemicals can be cost prohibitive.

Conventional application methods include broadcasting of granular agrochemicals (with pre-plant tilling or post-plant), foliar sprays, seed applications, and root drenches of liquid suspensions. Performance of granular formulations are enhanced by mixing through the upper 10 centimeters (cm) of soil, but this is not possible for mid-season application, treatment of annuals, no-till, intercropping, or agroforestry systems. Agrochemicals spread from granules but may not reach the root tips, especially as the plant grows. Root drenches promote delivery along the full length of root systems, but the high application rates required come with higher costs and the risk for adverse environmental impacts. In addition, water-mediated transport through soil is ineffective for hydrophobic agrochemicals, eliminating a substantial portion of otherwise effective agents. Without targeting capability, the entire soil volume must be treated despite the relatively small proportion of total soil volume that is comprised by the rhizosphere. Foliar sprays enable the direct treatment of at-risk leaves, but can fail to provide translocation, which is necessary to protect new leaves. Seed treatments, including coatings, place agrochemicals in close proximity to emerging roots, but growing roots may quickly extend beyond the zone of protection.

Water-mediated transport of agrochemicals through soil has several disadvantages including poor transmission, especially for hydrophobic agrochemicals, and the potential for wasted chemicals and adverse environmental impacts caused by runoff with excess rainfall. Mathematical modeling studies of chemical fate and transport in soils generally focus on passive, water-mediated mechanisms, despite the fact that other mechanisms exist, especially in the absence of percolating water. Some agrochemicals show low crop absorption for seed treatments, with overall recovery below 1.5% of the applied agrochemical. Facilitating transport and targeting delivery of agrochemicals in the rhizosphere could improve agrochemical efficacy at lower application rates, reducing both overall treatment cost and adverse environmental impacts by runoff by keeping the agrochemical near the crop roots for longer. Facilitating transport and targeting delivery may also enable the use of additional classes of agrochemicals as seed treatments. This both allows for additional “tools” for use against pests, which limit the downsides of regulatory limits, and helps prevent the development of pest resistance in the field.

Accordingly, developing compositions/agents/systems that facilitate the transport of agrochemicals and/or targeted delivery of the agrochemicals is of continuing interest.

### SUMMARY

Described herein are compositions and methods related to targeted delivery of agrochemicals to plants (for example, to plant roots), the composition including at least one soil protist and an agricultural payload, e.g., an agrochemical including insecticides, fungicides, nematicides, or combinations thereof. In an embodiment, the agrochemical is selected from the group consisting of insecticide, fungicide and nematicide.

In an aspect, disclosed is an agrochemical composition including an agriculturally suitable carrier; at least one encysted or sporulated protozoa (also referred to herein as “protist”); and an agricultural payload such as an agrochemical as described herein.

In an aspect, disclosed is an agrochemical composition including an agriculturally suitable carrier; an encysted or sporulated protozoa present in a formulation that is mixed with, incorporated into, applied to (e.g., coated on, adhered to), etc., the agriculturally suitable carrier; and an agricultural payload such as an agrochemical as shown and described herein.

In an aspect, disclosed is an agrochemical composition including an agriculturally suitable carrier; an encysted or sporulated protozoa present in a formulation that is mixed with, incorporated into, applied to (e.g., coated on, adhered to), etc., the agriculturally suitable carrier; and an agricultural payload including an agrochemical and a food source for protozoa such as a bacteria, as described herein.

In an aspect, disclosed herein are pesticidal compositions comprising at least one soil protist and an agrochemical selected from the group consisting of insecticide, fungicide and nematicide. Particular embodiments of the pesticidal compositions disclosed herein comprise at least one soil protist and an insecticide. In some embodiments, the insecticide is chlorantraniliprole. In some other embodiments, the insecticide is Spinosad. In some embodiments of the pesticidal compositions disclosed herein, the soil protist is Clopoda sp. Methods of using pesticidal compositions disclosed herein a soil application to prevent, mitigate, control or eliminate pest infestation or attack by pests are also disclosed.

In an aspect, disclosed is a method for improved plant growth, including administering a agrochemical composition disclosed herein to soil with an existing plant, or to soil where a plant or seed is to be planted.

In an aspect, a modified plant seed is provided. In some embodiments, the plant seed includes (i.) a plant seed; and (ii.) the agrochemical composition of the disclosure, wherein the composition is applied to (e.g., coated on, adhered to, etc.) at least part of the plant seed.

In an aspect, a method is provided that includes administering an agrochemical composition described herein to soil with an existing seed or plant, to soil where a plant or seed is to be planted, or to a seed or plant prior to planting, in which the method reduces plant loss to pests. In some embodiments, the pest is one or more of Phyla Arthropoda, Mollusca, and Nematoda 12.

In an aspect, a method is provided including the step of applying an agrochemical composition described herein to a medium where a crop plant is growing, to a seed or to a seed coating, in which the method controls or eliminates a pest infestation of the crop plant. In some embodiments, the medium where a crop plant is growing includes soil.

In an aspect, a method for treating a plant seed is provided, including coating at least part of a plant seed with an agrochemical composition described herein.

These and other aspects and embodiments of the disclosure are described in more detail below.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the invention. No attempt is made to show structural details of the invention in more detail than may be necessary for a fundamental understanding of the invention and various ways in which it may be practiced.

FIG. 1: A. “Growth Stage” experimental setup showing the randomized placement of pots with 48 representative plants were selected per treatment per experiment. B. Harvest and segmentation showing (inset) the “Pest Stage”. C. Pest Stage: Evaluation assay showing ˜75% damage caused by one FAW larvae.

FIG. 2: Box-and-whisker plot of feeding damage by treatment across all data points. Boxes contain the middle 50% of data points, and the median is marked by a line across a notch in each box. Individual plots are grouped by color and pattern (across matched pairs, e.g., Chloran and Chloran+protists) using Bonferroni-corrected pairwise t-tests-treatments colored/shaded similarly imply p >0.05 (although all are p >0.10); i.e., Baseline and +Protists. Different colors imply p<0.05 (although all are p<0.001), which applies to Chloran as compared to Chloran+Protists and Spinosad as compared to Spinosad+Protists. Treatments containing agrochemicals (Chlorantraniliprole, Chlorantraniliprole+Protists, Spinosad, Spinosad+Protists) are statistically distinct compared with treatments without agrochemicals (p<0.001). Treatments without agrochemicals (Baseline, Protists) show no significant differences (p >0.10).

FIG. 3: Feeding damage following treatment with Chlorantraniliprole, separated by leaf and section. Letters indicate statistical significance, where treatments with the same letter are statistically similar (p ≥0.050), while treatments with different letters are statistically different (p <0.050). Specifically, Chlorantraniliprole treatment shows a statistically significant difference from Baseline and Protist treatments in both segments of Leaf 3, Leaf 4 Tip, and Leaf 5 Tip (p<0.001). In all cases, the Chlorantraniliprole+Protists treatment had significantly less feeding damage than either Baseline or Protist treatments (p<0.001).

FIG. 4: Feeding damage following treatment with Spinosad separated by leaf and section. Letters indicate statistical significance, where treatments with the same letter are statistically similar (p ≥0.050), while treatments with different letters are statistically different (p <0.050). In the case of Leaf 5 Middle, the Spinosad treatment (AB) is statistically different from the Protist treatment (p=0.014), but does not meet the threshold for statistical difference from Baseline (p=0.053). In all other cases, Spinosad treatment shows a statistically significant difference from Baseline and Protist treatments. Feeding damage for Spinosad treatment is statistically different from Spinosad+Protists in all leaf segments.

FIG. 5: Root system expansion and delivery of insecticide to leaves following root-treatment. Seeds are treated during planting and the treatment diffuses away from seed to a small extent and provides a limited region of effective concentration (blurred shading or gradient around seed and also extensions along root paths for treatments with protists). Uptake of the treatment into a transpiring leaf is dependent on the surface area of the root system that is plumbed to that leaf and exposed to effective concentrations of the treatment. The figure shows approximate plant development from days 7 (A, D), 10 (B, E), and 14 (C, F). Gray (lighter colored in non-color reproductions) roots-present at day 7 and plumbed to transpiring leaves 1 and 2. Green roots consist of new roots and extensions of pre-existing roots that grew between days 7 and 10 (visible as new root sections when compared to day 7). Some of these are plumbed to leaf 3. Red roots consist of new roots and extensions of pre-existing roots that grew between days 10 and 14 (visible as black root extensions beyond growth of day 10). Much of this new tissue is outside the zone of effective treatment concentration. Some of this new tissue is plumbed to leaves 4 and 5 which matured between days 10 and 14. A, B, C show root exposure to treatment without the addition of protists. D, E, F depict a hypothesized increase in root system exposure to treatment because of transport by protists.

FIG. 6: Radio image of plant matter from 14° C. experiment containing A) Chlorantraniliprole with protists, and B) Chlorantraniliprole alone. Each section is labelled with combustion analysis results. The figure shows from the bottom up: stem, leaf 1, leaf 2, and leaf 3.

### DETAILED DESCRIPTION

Chemicals are an integral part of modern agriculture and are applied through a variety of methods. Some agrochemicals applied for crop protection function by absorption through the root before translocation to the rest of the plant. To be absorbed by the root, the agrochemical must first be transported through the soil, often by water. However, some agrochemicals suffer from poor water-based soil transmission due to their chemical properties, limiting their application as a traditional seed treatment. Two such agrochemicals, among many, are chlorantraniliprole and spinosad. Soil protists are an important component of the soil microbial community. Provided herein is evidence that a soil protists, like Colpoda sp., when co-inoculated with an agrochemical seed treatment, can substantially and robustly reduce subsequent pest feeding damage compared with the agrochemical alone. Using a maize leaf (Zea mays L.) and fall armyworm (Spodoptera frugiperda) damage assay, pest feeding damage and mortality in plants that received no additional treatment, only protists, only agrochemical, and co-inoculation of agrochemical with protists are compared. For both agrochemicals tested, the co-inoculation of protists with the agrochemical increased protection in leaves when the efficacy of the agrochemical alone declines. Protist amendment is a natural, inexpensive, chemical-free, soil-based transport enhancer that may be widely useful for more sustainable and cost-effective integrated pest management for plants.

The following terms are used to describe the invention of the present disclosure. In instances where a term is not specifically defined herein, that term is given an art-recognized meaning by those of ordinary skill applying that term in context to its use in describing the present disclosure.

Unless otherwise defined, all technical and scientific terms used herein have the same meaning as commonly understood by one of ordinary skill in the art. For example, any nomenclatures used in connection with, and techniques of, cell and tissue culture, molecular biology, immunology, microbiology, genetics, and protein and nucleic acid chemistry and hybridization described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, an “agriculturally suitable carrier” is any carrier on which the protozoa (protist) can be placed on or in to facilitate transport of agricultural payloads to the growing roots of a plant, and which is otherwise suitable for agricultural use. Regardless of the carrier used, the compositions of the invention allow for transport of the agricultural payload to the growing roots, since the protozoa are efficiently mobile in soils and will naturally target the roots. Thus, regardless of the specific agricultural payload or the concentration at which it is used, the compositions of the present invention will provide for a more effective delivery. Any such suitable carrier can be used, including but not limited to seeds, seed coats, granular carriers, liquid slurry carriers, and liquid suspension carriers. The carrier may constitute a majority of the composition (by volume or weight). Any suitable size of carrier can be used as determined most appropriate for a given application. In various non-limiting embodiments, standard sizes of powder-based carriers may vary from about 75 μm to about 0.25 mm, or granules and beads may range from about 100-200 μm to about 3-4 mm. In an embodiment, the standard sizes of powder-based carriers may vary from about 0.25 μm to about 25 μm. In an embodiment, the standard sizes of powder-based carriers may vary from about 0.5 μm to about 10 μm.

As used herein “agrochemical” are chemicals that can confer any type of benefit to a growing plant, including but not limited to nitrogen fixation, suppression of plant pathogen activity, antibiotics, pesticides, insecticides, growth factors, mobilization of nutrients from soil, moderating soil moisture, or a combination thereof.

The phrase “pesticidally effective amount” means the amount of a pesticide needed to achieve an observable effect on a pest, for example, the effects of necrosis, death, retardation, prevention, removal, destruction, or otherwise diminishing the occurrence and/or activity of a pest in a locus. This effect may come about when pest populations are repulsed from a locus, pests are incapacitated in or around a locus, and/or pests are exterminated in or around a locus. Of course, a combination of these effects can occur. Generally, pest populations, activity, or both are desirably reduced more than fifty percent, preferably more than 90 percent, and most preferably more than 99 percent. In general, a pesticidally effective amount, for agricultural purposes, is from about 0.0001 grams per hectare to about 5000 grams per hectare, preferably from about 0.0001 grams per hectare to about 500 grams per hectare, and it is even more preferably from about 0.0001 grams per hectare to about 50 grams per hectare.

The term “biologically-effective amount” refers to the amount of a biologically active compound (any of the compounds disclosed herein according to any aspect of the invention) sufficient to produce the desired biological effect when applied to (or contacted with) an invertebrate pest to be controlled to its environment, or to a plant, the seed from which the plant is grown, or the locus of the plant (e.g., growth medium) to protect the plant from injury by the invertebrate pest or for producing another desired effect such as increasing plant vigor.

As used herein, the term “plant” includes reference to the whole plant, plant seed, plant organ (e.g., leaves, stems, twigs, roots, trunks, limbs, shoots, fruits etc.), or plant cells. As used herein, the term “plant” includes reference to agricultural crops include field crops (e.g., soybean, maize, wheat, rice), vegetable crops (e.g., potatoes, cabbages) and fruits (e.g., peach, apple).

As used herein, “improved plant growth” includes any benefit that the plant may derive that improves plant growth or health, including but not limited to faster growth, improved disease or pest resistance, improved drought tolerance, higher yield, etc. The methods of the invention can be used to improve growth of any plant, including but not limited to crop plants, ornamental plants, trees, grasses, etc. Exemplary crop plants for which the methods of the invention can be used, include, but are not limited to fruits, vegetables, and grains including wheat, rice, corn, soybeans, beans, peanuts, potatoes, cassava, cotton, sugar cane, sorghum, tobacco, radishes, lettuce, tomatoes, peppers, alfalfa, etc.

As used herein, the term “administering” means the actual physical introduction of a composition into or onto (as appropriate) a plant as defined above. Any and all methods of introducing the composition into or onto the plant are contemplated according to the invention; the method is not dependent on any particular means of introduction and is not to be so construed. Means of introduction are well-known to those skilled in the art, and also are exemplified herein. “administering” can be used interchangeably with, e.g., “providing”, “giving”, and “dispensing.

The terms “treatment” or “treating” and their grammatical equivalents refer to the management of a seed or crop with an intent to cure, reverse, ameliorate, stabilize, or prevent a disease, condition, or disorder. Treatment may include causal treatment, that is, treatment directed toward removal of the cause of the associated disease, condition, or disorder, e.g., elimination of pests. Treatment may include preventative treatment, that is, treatment directed to minimizing or partially or completely inhibiting the development of a disease, condition, or disorder. Treatment may include active treatment, that is, treatment directed specifically toward the improvement of a disease, condition, or disorder. Treatment may include supportive treatment, that is, treatment employed to supplement another specific therapy directed toward the improvement of the disease, condition, or disorder. In some embodiments, a condition may be pathological. In some embodiments, a treatment may not completely cure.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements.

As used herein, the term “substantially” means to a great or significant extent, but not completely.

The terms “comprising”, “having”, “including”, and “containing” are to be construed as open-ended terms (i.e., meaning “including, but not limited to”) unless otherwise noted.

The use of any and all examples, or exemplary language (e.g., “such as”), is intended merely to better illustrate the invention and does not pose a limitation on the scope of the invention unless otherwise claimed. Likewise, the term “exemplary” is not intended to be construed as a superlative example but merely one of many possible examples. No language in the specification should be construed as indicating any non-claimed element as essential to the practice of the invention as used herein.

The terms “about” and “approximately”, as used herein, are inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or +5% of the stated value. Where no stated value is provided, an element described as “substantially” means at least about 60%, 70%, 80%, 90%, 95%, 99%, or more of the element, as is logically coherent within in the context. Unless specifically stated to the contrary, for ranges specified using “about” language, the about applies to both ends of the recited range whether specified or not. For example, “between about 10 μm and 10 mm” is equivalent to “between about 10 μm and about 10 mm”.

Recitation of ranges of values are merely intended to serve as a shorthand method of referring individually to each separate value falling within the range, unless otherwise indicated herein, and each separate value is incorporated into the specification as if it were individually recited herein. All ranges disclosed herein include both end points as discrete values as well as all integers and fractions specified within the range. For example, a range of 0.1-2.0 includes 0.1, 0.2, 0.3, 0.4 . . . 2.0. Moreover, recitation of a bounded range of values include internal subranges. For example, if a size range is stated as 1 nm to 100 nm (or concentrations, degrees, mass amounts, and the like), it is intended that values such as 2 nm to 90 nm, 10 nm to 70 nm, 30 nm to 95 nm, 75 nm to 100 nm, or 2 nm to 27 nm, etc., are expressly enumerated in this specification. These are only examples of what is specifically intended, and all possible combinations of numerical values between and including the lowest value and the highest value enumerated are to be considered to be expressly stated in this disclosure.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “one or more,” as used herein, means at least one, and thus includes individual components as well as mixtures/combinations of the listed components in any combination.

Other than in the operating examples, or where otherwise indicated, all numbers expressing quantities of ingredients and/or reaction conditions are to be understood as being modified in all instances by the term “about,” meaning within 10% of the indicated number (e.g., “about 10%” means, e.g., 9%-11% and “about 2%” means, e.g., 1.8%-2.2%).

All percentages and ratios are calculated by weight unless otherwise indicated. All percentages are calculated based on the total composition unless otherwise indicated. Generally, unless otherwise expressly stated herein, “weight” or “amount” as used herein with respect to the percent amount of an ingredient refers to the amount of the raw material comprising the ingredient, wherein the raw material may be described herein to comprise less than and up to 100% activity of the ingredient. Therefore, weight percent of an active in a composition is represented as the amount of raw material containing the active that is used and may or may not reflect the final percentage of the active, wherein the final percentage of the active is dependent on the weight percent of active in the raw material.

As used herein, “optional” or “optionally” means that the subsequently described event or circumstance may or may not occur, and that the description includes instances where said event or circumstance occurs and instances where it does not.

Turning to the various aspects and embodiments of the disclosure, provided herein are agrochemical compositions, methods for treating seeds with formulated insecticides and encysted or sporulated protozoa (protists) that substantially and robustly reduce subsequent feeding damage in a plant, for example in a maize leaf fall armyworm damage assay compared with similar plants treated with insecticides alone. The disclosure provides practical evidence for systemic benefits of co-application of soil protists. Seed treatments that include soil protists thus may enable lower therapeutic dosages in a variety of application modes (i.e., seed coatings, seed treatments, surface-applied granules) versus similar insecticide products formulated without protists. Protist amendment is a simple, natural, inexpensive, chemical-free, soil-based transport enhancer that thus may be widely useful in a variety of contexts including more sustainable and cost-effective integrated pest management.

In an aspect, the present invention provides agrochemical composition, including (a) an agriculturally suitable carrier; (b) encysted or sporulated protozoa (also referred to herein as “protist”) present on or in the agriculturally suitable carrier; and (c) an agricultural payload including an agrochemical (such as an insecticide, a pesticide, or a combination thereof). In an embodiment, the composition/agent/system and methods are for targeted delivery of agrochemicals to plants (for example, to plant roots) using an agriculturally suitable carrier such as a natural microbial carrier.

In an aspect, the present invention provides agrochemical composition, including (a) an agriculturally suitable carrier; (b) encysted or sporulated protozoa (also referred to herein as “protist”) present on or in the agriculturally suitable carrier; and (c) an agricultural payload including an agrochemical such as herbicides, fungicides, insecticides, nematicides, or a combination thereof and a food source for protozoa such as an agriculturally nonbeneficial bacteria.

In an aspect, disclosed herein are pesticidal compositions including agrochemicals and at least one protist, which are capable of transport and/or targeted delivery of the agrochemicals using the protists. In some aspects, the agrochemical is an insecticide. In other aspects, the agrochemical is a nematicide. In some other aspects, the agrochemical is a fungicide. In some aspects, the pesticidal compositions disclosed herein comprises more than one agrochemical. For example, the pesticidal compositions disclosed herein may comprise at least one insecticide and at least one fungicide. An “agrochemical” means any suitable insecticide, fungicide, nematicide, micro or macronutrient, or a plant growth regulator (PGR). In particular, the term “agrochemical” encompasses any organic or inorganic chemical or a chemical compound that exerts a beneficial effect on a crop plant.

Any suitable agrochemical in biologically effective amounts can be used in the pesticidal compositions disclosed herein.

The inventors of the present invention have unexpectedly discovered that the compositions of the present invention can be used, for example, to promote significantly improved transport and dispersal of agricultural payloads such as agrochemicals with or without a food source for protozoa such as an agriculturally nonbeneficial bacteria to rapidly growing plant roots by active transport via protozoan (also referred to herein as “protist”) carriers than would be possible in the absence of the protozoan carriers.

The agrochemical compositions disclosed herein address the issues of poor water solubility and poor transferability (e.g., passive transport in soil) of certain agrochemicals. It is difficult for these agrochemicals to reach the roots so that they can be absorbed by the plants. For example, certain agrochemicals having appreciable water solubility and certain reduced hydrophobicity can dissolve in water and reach the roots efficiently. For example, the preferred solubility ranges for such agrochemicals are water solubility within the range of about 50-600 ppm and hydrophobicity (log K_{ow}) about 0.75-2.5. Agrochemicals outside of these ranges are unable to efficiently reach roots, rendering them economically and/or environmentally infeasible due to, e.g., excessive concentrations being needed to reach roots or labor intensive application processes. The inventors unexpectedly found that the unfavorable chemical characteristics of such agrochemicals can be overcome by protist-mediated transportation or targeted delivery. For example, the water solubility and log K_{ow} of chlorantraniliprole is about 2.5 ppm and about 721 ppm respectively. Similarly, water solubility and log K_{ow} of Spinosad is about 2 ppm and about 3.2 ppm respectively. These are good candidates for the agrochemical compositions disclosed herein as shown in the Examples. Specifically, agrochemicals having water solubility less than about 50 ppm and log K_{ow} higher than about 2.5 are ideal candidates for the agrochemical compositions disclosed herein, which can unexpectedly, given their active delivery, render previously unusable agrochemicals important additions to agribusiness.

In some embodiments, the water solubility of the agrochemical is between about 0.1 ppm and 50 ppm, or between about 0.1 ppm and about 45 ppm, or between about 0.1 ppm and about 40 ppm, or between about 0.1 ppm and about 35 ppm, or between about 0.1 ppm and about 30 ppm, or between about 0.1 ppm and about 25 ppm, or between about 0.1 ppm and about 20 ppm, or between about 0.1 ppm and about 15 ppm, or between about 0.1 ppm and about 10 ppm, or between about 0.1 ppm and about 5 ppm, or between about 0.1 ppm and about 4 ppm, or between about 0.1 ppm and about 3 ppm, or between about 0.1 ppm and about 2 ppm, or between about 0.1 ppm and about 1 ppm, or between about 1 ppm and 50 ppm, or between about 1 ppm and about 45 ppm, or between about 1 ppm and about 40 ppm, or between about 1 ppm and about 35 ppm, or between about 1 ppm and about 30 ppm, or between about 1 ppm and about 25 ppm, or between about 1 ppm and about 20 ppm, or between about 1 ppm and about 15 ppm, or between about 1 ppm and about 10 ppm, or between about 1 ppm and about 5 ppm, or between about 1 ppm and about 4 ppm, or between about 1 ppm and about 3 ppm, or between about 1 ppm and about 2 ppm, or between about 2 ppm and 50 ppm, or between about 2 ppm and about 45 ppm, or between about 2 ppm and about 40 ppm, or between about 2 ppm and about 35 ppm, or between about 2 ppm and about 30 ppm, or between about 2 ppm and about 25 ppm, or between about 2 ppm and about 20 ppm, or between about 2 ppm and about 15 ppm, or between about 2 ppm and about 10 ppm, or between about 2 ppm and about 5 ppm, or between about 2 ppm and about 4 ppm, or between about 2 ppm and about 3 ppm, or between about 3 ppm and 50 ppm, or between about 3 ppm and about 45 ppm, or between about 3 ppm and about 40 ppm, or between about 3 ppm and about 35 ppm, or between about 3 ppm and about 30 ppm, or between about 3 ppm and about 25 ppm, or between about 3 ppm and about 20 ppm, or between about 3 ppm and about 15 ppm, or between about 3 ppm and about 10 ppm, or between about 3 ppm and about 5 ppm, or between about 3 ppm and about 4 ppm, or between about 4 ppm and 50 ppm, or between about 4 ppm and about 45 ppm, or between about 4 ppm and about 40 ppm, or between about 4 ppm and about 35 ppm, or between about 4 ppm and about 30 ppm, or between about 4 ppm and about 25 ppm, or between about 4 ppm and about 20 ppm, or between about 4 ppm and about 15 ppm, or between about 4 ppm and about 10 ppm, or between about 4 ppm and about 5 ppm, or between about 5 ppm and 50 ppm, or between about 5 ppm and about 45 ppm, or between about 5 ppm and about 40 ppm, or between about 5 ppm and about 35 ppm, or between about 5 ppm and about 30 ppm, or between about 5 ppm and about 25 ppm, or between about 5 ppm and about 20 ppm, or between about 5 ppm and about 15 ppm, or between about 5 ppm and about 10 ppm, or between about 7.5 ppm and 50 ppm, or between about 7.5 ppm and about 45 ppm, or between about 7.5 ppm and about 40 ppm, or between about 7.5 ppm and about 35 ppm, or between about 7.5 ppm and about 30 ppm, or between about 7.5 ppm and about 25 ppm, or between about 7.5 ppm and about 20 ppm, or between about 7.5 ppm and about 15 ppm, or between about 7.5 ppm and about 10 ppm, or between about 10 ppm and 50 ppm, or between about 10 ppm and about 45 ppm, or between about 10 ppm and about 40 ppm, or between about 10 ppm and about 35 ppm, or between about 10 ppm and about 30 ppm, or between about 10 ppm and about 25 ppm, or between about 10 ppm and about 20 ppm, or between about 10 ppm and about 15 ppm, or between about 15 ppm and 50 ppm, or between about 15 ppm and about 45 ppm, or between about 15 ppm and about 40 ppm, or between about 15 ppm and about 35 ppm, or between about 15 ppm and about 30 ppm, or between about 15 ppm and about 25 ppm, or between about 15 ppm and about 20 ppm, or between about 20 ppm and 50 ppm, or between about 20 ppm and about 45 ppm, or between about 20 ppm and about 40 ppm, or between about 20 ppm and about 35 ppm, or between about 20 ppm and about 30 ppm, or between about 20 ppm and about 25 ppm, or between about 25 ppm and 50 ppm, or between about 25 ppm and about 45 ppm, or between about 25 ppm and about 40 ppm, or between about 25 ppm and about 35 ppm, or between about 25 ppm and about 30 ppm, or less than about 0.1 ppm, or less than about 0.25 ppm, or less than about 0.5 ppm, or less than about 0.75 ppm, or less than about 1 ppm, or less than about 2 ppm, or less than about 3 ppm, or less than about 4 ppm, or less than about 5 ppm, or less than about 6 ppm, or less than about 7 ppm, or less than about 8 ppm, or less than about 9 ppm, or less than about 10 ppm, or less than about 12.5 ppm, or less than about 15 ppm, or less than about 17.5 ppm, or less than about 20 ppm, or less than about 25 ppm, or less than about 25 ppm, or less than about 30 ppm, or less than about 35 ppm, or less than about 40 ppm, or less than about 45 ppm, or less than 50 ppm.

In some embodiments, the hydrophobicity of the agrochemical is a log K_{ow} of between about 2.5 and about 1000, or between about 2.6 and about 1000, or between about 2.7 and about 1000, or between about 2.8 and about 1000, or between about 2.9 and about 1000, or between about 3.0 and about 1000, or between about 3.1 and about 1000, or between about 3.2 and about 1000, or between about 3.3 and about 1000, or between about 3.4 and about 1000, or between about 3.5 and about 1000, or between about 3.6 and about 1000, or between about 3.7 and about 1000, or between about 3.8 and about 1000, or between about 3.9 and about 1000, or between about 4.0 and about 1000, or between about 4.1 and about 1000, or between about 4.2 and about 1000, or between about 4.3 and about 1000, or between about 4.4 and about 1000, or between about 4.5 and about 1000, or between about 4.6 and about 1000, or between about 4.7 and about 1000, or between about 4.8 and about 1000, or between about 4.9 and about 1000, or between about 5.0 and about 1000, or between about 2.5 and about 750, or between about 2.6 and about 750, or between about 2.7 and about 750, or between about 2.8 and about 750, or between about 2.9 and about 750, or between about 3.0 and about 750, or between about 3.1 and about 750, or between about 3.2 and about 750, or between about 3.3 and about 750, or between about 3.4 and about 750, or between about 3.5 and about 750, or between about 3.6 and about 750, or between about 3.7 and about 750, or between about 3.8 and about 750, or between about 3.9 and about 750, or between about 4.0 and about 750, or between about 4.1 and about 750, or between about 4.2 and about 750, or between about 4.3 and about 750, or between about 4.4 and about 750, or between about 4.5 and about 750, or between about 4.6 and about 750, or between about 4.7 and about 750, or between about 4.8 and about 750, or between about 4.9 and about 750, or between about 5.0 and about 750, or between about 2.5 and about 500, or between about 2.6 and about 500, or between about 2.7 and about 500, or between about 2.8 and about 500, or between about 2.9 and about 500, or between about 3.0 and about 500, or between about 3.1 and about 500, or between about 3.2 and about 500, or between about 3.3 and about 500, or between about 3.4 and about 500, or between about 3.5 and about 500, or between about 3.6 and about 500, or between about 3.7 and about 500, or between about 3.8 and about 500, or between about 3.9 and about 500, or between about 4.0 and about 500, or between about 4.1 and about 500, or between about 4.2 and about 500, or between about 4.3 and about 500, or between about 4.4 and about 500, or between about 4.5 and about 500, or between about 4.6 and about 500, or between about 4.7 and about 500, or between about 4.8 and about 500, or between about 4.9 and about 500, or between about 5.0 and about 500, or between about 2.5 and about 250, or between about 2.6 and about 250, or between about 2.7 and about 250, or between about 2.8 and about 250, or between about 2.9 and about 250, or between about 3.0 and about 250, or between about 3.1 and about 250, or between about 3.2 and about 250, or between about 3.3 and about 250, or between about 3.4 and about 250, or between about 3.5 and about 250, or between about 3.6 and about 250, or between about 3.7 and about 250, or between about 3.8 and about 250, or between about 3.9 and about 250, or between about 4.0 and about 250, or between about 4.1 and about 250, or between about 4.2 and about 250, or between about 4.3 and about 250, or between about 4.4 and about 250, or between about 4.5 and about 250, or between about 4.6 and about 250, or between about 4.7 and about 250, or between about 4.8 and about 250, or between about 4.9 and about 250, or between about 5.0 and about 250, or between about 2.5 and about 100, or between about 2.6 and about 100, or between about 2.7 and about 100, or between about 2.8 and about 100, or between about 2.9 and about 100, or between about 3.0 and about 100, or between about 3.1 and about 100, or between about 3.2 and about 100, or between about 3.3 and about 100, or between about 3.4 and about 100, or between about 3.5 and about 100, or between about 3.6 and about 100, or between about 3.7 and about 100, or between about 3.8 and about 100, or between about 3.9 and about 100, or between about 4.0 and about 100, or between about 4.1 and about 100, or between about 4.2 and about 100, or between about 4.3 and about 100, or between about 4.4 and about 100, or between about 4.5 and about 100, or between about 4.6 and about 100, or between about 4.7 and about 100, or between about 4.8 and about 100, or between about 4.9 and about 100, or between about 5.0 and about 100, or between about 2.5 and about 50, or between about 2.6 and about 50, or between about 2.7 and about 50, or between about 2.8 and about 50, or between about 2.9 and about 50, or between about 3.0 and about 50, or between about 3.1 and about 50, or between about 3.2 and about 50, or between about 3.3 and about 50, or between about 3.4 and about 50, or between about 3.5 and about 50, or between about 3.6 and about 50, or between about 3.7 and about 50, or between about 3.8 and about 50, or between about 3.9 and about 50, or between about 4.0 and about 50, or between about 4.1 and about 50, or between about 4.2 and about 50, or between about 4.3 and about 50, or between about 4.4 and about 50, or between about 4.5 and about 50, or between about 4.6 and about 50, or between about 4.7 and about 50, or between about 4.8 and about 50, or between about 4.9 and about 50, or between about 5.0 and about 50, or between about 2.5 and about 25, or between about 2.6 and about 25, or between about 2.7 and about 25, or between about 2.8 and about 25, or between about 2.9 and about 25, or between about 3.0 and about 25, or between about 3.1 and about 25, or between about 3.2 and about 25, or between about 3.3 and about 25, or between about 3.4 and about 25, or between about 3.5 and about 25, or between about 3.6 and about 25, or between about 3.7 and about 25, or between about 3.8 and about 25, or between about 3.9 and about 25, or between about 4.0 and about 25, or between about 4.1 and about 25, or between about 4.2 and about 25, or between about 4.3 and about 25, or between about 4.4 and about 25, or between about 4.5 and about 25, or between about 4.6 and about 25, or between about 4.7 and about 25, or between about 4.8 and about 25, or between about 4.9 and about 25, or between about 5.0 and about 25, or between about 2.5 and about 10, or between about 2.6 and about 10, or between about 2.7 and about 10, or between about 2.8 and about 10, or between about 2.9 and about 10, or between about 3.0 and about 10, or between about 3.1 and about 10, or between about 3.2 and about 10, or between about 3.3 and about 10, or between about 3.4 and about 10, or between about 3.5 and about 10, or between about 3.6 and about 10, or between about 3.7 and about 10, or between about 3.8 and about 10, or between about 3.9 and about 10, or between about 4.0 and about 10, or between about 4.1 and about 10, or between about 4.2 and about 10, or between about 4.3 and about 10, or between about 4.4 and about 10, or between about 4.5 and about 10, or between about 4.6 and about 10, or between about 4.7 and about 10, or between about 4.8 and about 10, or between about 4.9 and about 10, or between about 5.0 and about 10, or between about 10 and about 1000, or between about 15 and about 1000, or between about 20 and about 1000, or between about 25 and about 1000, or between about 30 and about 1000, or between about 35 and about 1000, or between about 40 and about 1000, or between about 45 and about 1000, or between about 50 and about 1000, or between about 55 and about 1000, or between about 60 and about 1000, or between about 65 and about 1000, or between about 70 and about 1000, or between about 75 and about 1000, or between about 80 and about 1000, or between about 85 and about 1000, or between about 90 and about 1000, or between about 95 and about 1000, or between about 100 and about 1000, or between about 200 and about 1000, or between about 300 and about 1000, or between about 400 and about 1000, or between about 500 and about 1000, or between about 600 and about 1000, or between about 700 and about 1000, or between about 800 and about 1000, or between about 900 and about 1000, or greater than about 2.6, or greater than about 2.7, or greater than about 2.8, or greater than about 2.9, or greater than about 3.0, or greater than about 3.1, or greater than about 3.2, or greater than about 3.3, or greater than about 3.4, or greater than about 3.5, or greater than about 3.6, or greater than about 3.7, or greater than about 3.8, or greater than about 3.9, or greater than about 4.0, or greater than about 4.1, or greater than about 4.2, or greater than about 4.3, or greater than about 4.4, or greater than about 4.5, or greater than about 4.6, or greater than about 4.7, or greater than about 4.8, or greater than about 4.9, or greater than about 5.0, or greater than about 6, or greater than about 7, or greater than about 8, or greater than about 9, or greater than about 10, or greater than about 12.5, or greater than about 15, or greater than about 20, or greater than about 25, or greater than about 30, or greater than about 35, or greater than about 40, or greater than about 45, or greater than about 50, or greater than about 55, or greater than about 60, or greater than about 65, or greater than about 70, or greater than about 75, or greater than about 80, or greater than about 85, or greater than about 90, or greater than about 95, or greater than about 100, or greater than about 200, or greater than about 300, or greater than about 400, or greater than about 500, or greater than about 600, or greater than about 700, or greater than about 800, or a log K_{ow} of greater than about 900.

In addition, in some embodiments, agrochemicals with water solubility within the range of about 50-600 ppm and hydrophobicity (log K_{ow}) about 0.75-2.5 may also be suitable for protist-mediated transportation or targeted delivery with the potential for reduced application rates compared to bulk application.

In addition to the particular physiochemical properties, the agrochemicals selected herein have a desired toxicity profile. For example, in the presence of the agrochemical, the live protists in a concentrated solution should remain viable and active.

The agrochemical is selected from the following compounds: abamectin, acephate, acequinocyl, acetamiprid, acrinathrin, acynonapyr, afidopyropen, alanycarb, aldicarb, allethrin, alpha-cypermethrin, aminopyralid, amitraz, azadirachtin, azamethiphos, azinphos-ethyl, azinphos-methyl, azocyclotin, azoxystrobin, bendiocarb, benfuracarb, bensultap, benzoximate, benzpyrimoxan, beta-cyfluthrin, beta-cypermethrin, bifenazate, bifenthrin, bioallethrin, bioresmethrin, bistrifluron, broflanilide, bromopropylate, buprofezin, butocarboxim, butoxycarboxim, cadusafos, carbaryl, carbofuran, carbosulfan, carboxin, cartap hydrochloride, chinomethionat, chlorantraniliprole, chlordane, chlorethoxyfos, chlorfenapyr, chlorfenvinphos, chlorfluazuron, chlormephos, chlorpyrifos, chlorpyrifos-methyl, chromafenozide, clofentezine, clopyralid, cloquintocet, clothianidin, copper hydroxide, coumaphos, cyanophos, cyantraniliprole, cyclaniliprole, cyclobutrifluram, cycloprothrin, cycloxaprid, cyenopyrafen, cyflumetofen, cyfluthrin, cyhalothrin, cyhexatin, cymoxanil, cypermethrin, cyphenothrin, cyproflanilide, cyromazine, d-cis-trans allethrin, DDVP, deltamethrin, demeton-S-methyl, diafenthiuron, diazinon, dichlorvos, dicofol, dicrotophos, difenoconazole, diflovidazin, diflubenzuron, dimethoate, dimethylvinphos, dimpropyridaz, dinotefuran, disulfoton, DNOC, d-trans allethrin, emamectin, emamectin benzoate, empenthrin, endosulfan, EPN, esfenvalerate, ethaboxam, ethiofencarb, ethion, ethiprole, ethoprophos, etofenprox, famoxadone, famphur, fenamiphos, fenazaquin, fenbuconazole, fenbutatin oxide, fenitrothion, fenmezoditiaz, fenobucarb, fenoxycarb, fenpropathrin, fenpyroximate, fenthion, fenvalerate, fipronil, flazasulfuron, flonicamid, florasulam, fluacrypyrim, fluazaindolizine, flubendiamide, flucycloxuron, flucythrinate, fludioxonil, fluensulfone, flufenoxuron, flumethrin, flumioxazin, fluopyram, fluoxapiprolin, fluoxastrobin, flupyradifurone, flupyrimin, fluroxypyr, fluxametamide, fluxapyroxad, formetanate, fosthiazate, furathiocarb, gamma-cyhalothrin, glyphosate, halauxifen, halfenprox, halofenozide, heptenophos, hexaflumuron, hexythiazox, hydramethylnon, hydroprene, imazamox, imazapyr, imicyafos, imidacloprid, imiprothrin, indazapyroxamet, indoxacarb, inpyrfluxam, ipconazole, isocycloseram, isofenphos, isoflucypram, isoprocarb, isoxathion, kadethrin, kinoprene, lambda-cyhalothrin, lepimectin, lufenuron, malathion, mancozeb, MCPA, mecarbam, mefenoxam, metaflumizone, metalaxyl, metconazole, methamidophos, methenamine, methidathion, methiocarb, methomyl, methoprene, methoxychlor, methoxyfenozide, metolcarb, metsulfuron, mevinphos, milbemectin, monocrotophos, myclobutanil, naled, nicosulfuron, nitrapyrin, novaluron, noviflumuron, omethoate, oxamyl, oxathiapiprolin, oxazosulfyl, oxydemeton-methyl, parathion, parathion-methyl, penflufen, penthiopyrad, permethrin, phenothrin, phenthoate, phorate, phosalone, phosmet, phosphamidon, phoxim, picarbutrazox, picloram, picoxystrobin, pinoxaden, pirimicarb, pirimiphos-methyl, prallethrin, profenofos, propargite, propetamphos, propiconazole, propoxur, propyzamide, prothioconazole, prothiofos, spiflumetofen, pyflubumide, pymetrozine, pyraclofos, pyraclostrobin, pyrethrum, pyridaben, pyridalyl, pyridaphenthion, pyrifluquinazon, pyrimidifen, pyriproxyfen, pyroxasulfone, quinalphos, resmethrin, rimsulfuron, rotenone, sedaxane, silafluofen, spidoxamat, spinetoram, spinosad, spirobudifen, spirodiclofen, spiromesifen, spiropidion, spirotetramat, sulfluramid, sulfotep, sulfoxaflor, tau-fluvalinate, tebuconazole, tebufenozide, tebufenpyrad, tebupirimfos, teflubenzuron, tefluthrin, temephos, terbufos, tetrachlorvinphos, tetradifon, tetramethrin, tetraniliprole, theta-cypermethrin, thiabendazole, thiamethoxam, thiocyclam, thiodicarb, thiofanox, thiometon, thiosultap-sodium, thiram, tiorantraniliprole, tioxazafen, tolfenpyrad, tralkoxydim, tralomethrin, transfluthrin, triazamate, triazophos, trichlorfon, triclopyr, trifloxystrobin, triflumezopyrim, triflumuron, trimethacarb, vamidothion, XMC, xylylcarb, zeta-cypermethrin, 2,4-D, or any combination thereof.

In an embodiment, the agrochemical is AI-1:

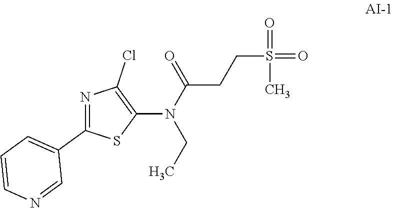 [SMILES: CCN(C(=O)CCS(C)(=O)=O)c1sc(-c2cccnc2)nc1Cl]

In an embodiment, the agrochemical is an insecticide selected from the following compounds: 1,3-dichloropropene, abamectin, acephate, acequinocyl, acetamiprid, acetoprole, afidopyropen, avermectin, azinphos-methyl, benzpyrimoxan, bifenazate, bifenthrin, broflanilide, buprofezin, carbaryl, carbofuran, chlorantraniliprole, chlorfenapyr, chlorfluazuron chlorpyrifos, chromafenozide, clothianidin, cyantraniliprole, cyclaniliprole, cycloxaprid, cyfluthrin, cypermethrin, cyproflanilide, deltamethrin, diafenthiuron, dimpropyridaz, dinotefuran, emamectin benzoate, endosulfan, esfenvalerate, ethiprole, etoxazole, fenmezoditiaz, fipronil, flonicamid, fluacrypyrim, flubendiamide, flupyradifurone, flupyrimin, fluxametamide gamma-cyhalothrin, halofenozide, hexaflumuron, imidacloprid, indazapyroxamet, indoxacarb, isocycloseram, lambda cyhalothrin, lufenuron, malathion, methomyl, methoxyfenozide, novaluron, noviflumuron, oxamyl, oxazosulfyl permethrin, pymetrozine, pyridalyl, pyrifluquinazon, pyrimidifen, pyriproxyfen, spidoxamat, spinetoram, spinosad, spirodiclofen, spiromesifen, spiropidion, spirotetramat, sulfoxaflor, tebufenozide, tetraniliprole, thiacloprid, thiamethoxam, thiodicarb, tolfenpyrad, triflumezopyrim, zeta-cypermethrin, or any combination thereof.

In an embodiment, the agrochemical is a nematicide selected from the following compounds: abamectin, cyclobutrifluram, fluensulfone, fluopyram, oxamyl, reklemel, tioxazafen, or any combination thereof. In an embodiment, the agrochemical is cyantraniliprole. In an embodiment, the agrochemical is chlorantraniliprole. In an embodiment, the agrochemical is spinetoram. In an embodiment, the agrochemical is Spinosad. In an embodiment, the agrochemical is a fungicide.

In an embodiment, the fungicide is selected from the following compounds: metalaxyl, mefenoxam, ipconazole, fludioxonil, azoxystrobin, inpyrfluxam, ethaboxam, oxathiapiprolin, sedaxane, fluopyram, difenoconazole, picoxystrobin, prothioconazole, penflufen, thiabendazole, tebuconazole, cyclobutrifluram, pydiflumetofen, fluoxastrobin, fluxapyroxad, copper Hydroxide, trifloxystrobin, thiram, fluoxapiprolin, isoflucypram, metconazole, picarbutrazox, or any combination thereof.

The agrochemical compositions disclosed herein also comprise a protist. The protist acts as a transportation medium or act as an agent for targeted delivery of the agrochemicals to the plant roots through the medium in which the plant is growing. In particular, the protist is a phagotropic soil protist. In an embodiment, the protist is Amoeba sp. (Amoeba proteus, Acanthamoeba sp., Hartmannella sp.); flagellates (Heteromita sp., Cercomonas so., Bodo sp.); ciliates (Colpoda sp., Tetrahymena sp., Oxytricha sp.); cercozoans (Cercomonads, Thecofilosea); Rhizaria (Gromia sp., Filose amoebae); Testate amoebae (Arcellidae (Arcella sp.), Euglyphida (Euglypha sp.); Heliozoa (Actinophrys sp., Actinosphaerium sp.); and euglenoids (Euglena sp.); Acanthamoeba; Dictyostelium; Heteromita; Vahlkampfia; Stachyamoeba; Proleptomonas; Colpodea; Thecamonas; Bodo; Neobodo; Dimastigella; Rhynchomonas; Ochromonas; Spumella; Tetrahymena; Euplotes; Blepharisma; Vorticella; Hartmannella; Phalansterium; Cercomonas; Phalansterium; or combinations thereof.

Any suitable protozoan species that is capable of (a) encystment or sporulation, and (b) motility can be used in the compositions of the present invention. The specific type of protozoan to use in a composition will depend on all variables, including but not limited to the vehicle to be used, the plant to be treated with the composition, the soil type, the agricultural payload to be delivered in conjunction with the protozoa, etc. In various non-limiting embodiments, the protozoan may be of the genus Acanthamoeba, Dictyostelium, Heteromita, Vahlkampfia, Stachyamoeba, Proleptomonas, Class COLPODEA, Thecamonas, Bodo, Neobodo, Dimastigella, Rhynchomonas, Ochromonas, Spumella, Tetrahymena, Euplotes, Blepharisma, Vorticella, Hartmannella, Phalansterium, Colpoda, Phylum CERCOZOA, Cercomonas, Phalansterium, and combinations thereof. In non-limiting specific examples, the protozoan may be Colpoda sp., Cercomonas sp., and combinations thereof.

Particular embodiments of the agrochemical compositions disclosed herein comprise Colpoda sp. In some embodiments, the agrochemical compositions comprise Colpoda sp., and an insecticide. In some instances, the insecticide is chlorantraniliprole. In some other instances, the insecticide is Spinosad.

The agrochemical compositions can be applied directly to the medium that a plant grows. Preferably, the composition is applied close to the rhizosphere so that emerging roots can access the composition. In some instances, the composition is applied to a seed or a seed coating.

Disclosed herein also a use of the agrochemical compositions to control or combat a pesticidal infestation. Terms “control” or “combat” have been used interchangeably throughout this disclosure; that is terms “control” and “combat” mean reduce or maintain the pesticidal infestation to desired levels, or prevent further spreading of a pesticidal infestation. The use may also include preventing a pesticidal infestation before it occurs. The use may include termination of a pesticidal infestation. “Termination” in this context means reducing an infestation more than 80%, more than 90%, more than 95% or 100%. The terms “termination” and “elimination” have been used interchangeably throughout this disclosure. Disclosed herein is also a method of controlling or eliminating a pest infestation in a crop plant by applying the agrochemical compositions disclosed herein to the medium in which the crop plant grows. The medium can be soil, water, or any other medium in which a plant can grow. In particular embodiments, the medium is soil. A plant can be any plant or a crop of agronomical importance. In particular, the crops or plants are selected from the group consisting of alfalfa, almonds, apples, barley, beans, canola, corn, cotton, crucifers, flowers, fodder species (Rye Grass, Sudan Grass, Tall Fescue, Kentucky Blue Grass, and Clover), fruits, lettuce, oats, oil seed crops, oranges, peanuts, pears, peppers, potatoes, rice, sorghum, soybeans, strawberries, sugarcane, sugar beets, sunflowers, tobacco, tomatoes, wheat (for example, Hard Red Winter Wheat, Soft Red Winter Wheat, White Winter Wheat, Hard Red Spring Wheat, and Durum Spring Wheat). The agrochemical compositions disclosed herein can be applied to the locus of the plant and “locus” in this context means habitat, soil, material or environment in which a plant is growing or may grow.

The term “pest” means an organism that is detrimental to humans, or human concerns (such as, crops, food, livestock, etc.), where said organism is from Phyla Arthropoda, Mollusca, or Nematoda. Particular examples are ants, aphids, bed bugs, beetles, bristletails, caterpillars, cockroaches, crickets, earwigs, fleas, flies, grasshoppers, grubs, hornets, jassids, leafhoppers, lice, locusts, maggots, mealybugs, mites, moths, nematodes, plantbugs, planthoppers, psyllids, sawflies, scales, silverfish, slugs, snails, spiders, springtails, stink bugs, symphylans, termites, thrips, ticks, wasps, whiteflies, and wireworms.

Additional nonlimiting examples are pests in:

(1) Subphyla Chelicerata, Myriapoda, and Hexapoda.

(2) Classes of Arachnida, Symphyla, and Insecta.

(3) Order Anoplura. A non-exhaustive list of particular genera includes, but is not limited to, Haematopinus spp., Hoplopleura spp., Linognathus spp., Pediculus spp., Polyplax spp., Solenopotes spp., and Neohaematopinis spp. A non-exhaustive list of particular species includes, but is not limited to, Haematopinus asini, Haematopinus suis, Linognathus setosus, Linognathus ovillus, Pediculus humanus capitis, Pediculus humanus humanus, and Pthirus pubis.

(4) Order Coleoptera. A non-exhaustive list of particular genera includes, but is not limited to, Acanthoscelides spp., Agriotes spp., Anthonomus spp., Apion spp., Apogonia spp., Araecerus spp., Aulacophora spp., Bruchus spp., Cerosterna spp., Cerotoma spp., Ceutorhynchus spp., Chaetocnema spp., Colaspis spp., Ctenicera spp., Curculio spp., Cyclocephala spp., Diabrotica spp., Dinoderus spp., Gnathocerus spp., Hemicoelus spp., Heterobostruchus spp., Hypera spp., Ips spp., Lyctus spp., Megascelis spp., Meligethes spp., Mezium spp., Niptus spp., Otiorhynchus spp., Pantomorus spp., Phyllophaga spp., Phyllotreta spp., Ptinus spp., Rhizotrogus spp., Rhynchites spp., Rhynchophorus spp., Scolytus spp., Sphenophorus spp., Sitophilus spp., Tenebrio spp., and Tribolium spp. A non-exhaustive list of particular species includes, but is not limited to, Acanthoscelides obtectus, Agrilus planipennis, Ahasverus advena, Alphitobius diaperinus, Anoplophora glabripennis, Anthonomus grandis, Anthrenus verbasci, Anthrenus falvipes, Ataenius spretulus, Atomaria linearis, Attagenus unicolor, Bothynoderes punctiventris, Bruchus pisorum, Callosobruchus maculatus, Carpophilus hemipterus, Cassida vittata, Cathartus quadricollis, Cerotoma trifurcata, Ceutorhynchus assimilis, Ceutorhynchus napi, Conoderus scalaris, Conoderus stigmosus, Conotrachelus nenuphar, Cotinis nitida, Crioceris asparagi, Cryptolestes ferrugineus, Cryptolestes pusillus, Cryptolestes turcicus, Cylindrocopturus adspersus, Deporaus marginatus, Dermestes lardarius, Dermestes maculatus, Epilachna varivestis, Euvrilletta peltata, Faustinus cubae, Hylobius pales, Hylotrupes bajulus, Hypera postica, Hypothenemus hampei, Lasioderma serricorne, Leptinotarsa decemlineata, Limonius canus, Liogenys fuscus, Liogenys suturalis, Lissorhoptrus oryzophilus, Lophocateres pusillus, Lyctus planicollis, Maecolaspis joliveti, Melanotus communis, Meligethes aeneus, Melolontha melolontha, Necrobia rufipes, Oberea brevis, Oberea linearis, Oryctes rhinoceros, Oryzaephilus mercator, Oryzaephilus surinamensis, Oulema melanopus, Oulema oryzae, Phyllophaga cuyabana, Polycaon stoutti, Popillia japonica, Prostephanus truncatus, Rhyzopertha dominica, Sitona lineatus, Sitophilus granarius, Sitophilus oryzae, Sitophilus zeamais, Stegobium paniceum, Tenebroides mauritanicus, Tribolium castaneum, Tribolium confusum, Trogoderma granarium, Trogoderma variabile, Xestobium rufovillosum, and Zabrus tenebrioides.

(5) Order Dermaptera. A non-exhaustive list of particular species includes, but is not limited to, Forficula auricularia.

(6) Order Blattaria. A non-exhaustive list of particular species includes, but is not limited to, Blattella germanica, Blattella asahinai, Blatta orientalis, Blatta lateralis, Parcoblatta pennsylvanica, Periplaneta americana, Periplaneta australasiae, Periplaneta brunnea, Periplaneta fuliginosa, Pycnoscelus surinamensis, and Supella longipalpa.

(7) Order Diptera. A non-exhaustive list of particular genera includes, but is not limited to, Aedes spp., Agromyza spp., Anastrepha spp., Anopheles spp., Bactrocera spp., Ceratitis spp., Chrysops spp., Cochliomyia spp., Contarinia spp., Culex spp., Culicoides spp., Dasineura spp., Delia spp., Drosophila spp., Fannia spp., Hylemya spp., Liriomyza spp., Musca spp., Phorbia spp., Pollenia spp., Psychoda spp., Simulium spp., Tabanus spp., and Tipula spp. A non-exhaustive list of particular species includes, but is not limited to, Agromyza frontella, Anastrepha suspensa, Anastrepha ludens, Anastrepha obliqua, Bactrocera cucurbitae, Bactrocera dorsalis, Bactrocera invadens, Bactrocera zonata, Ceratitis capitata, Dasineura brassicae, Delia platura, Fannia canicularis, Fannia scalaris, Gasterophilus intestinalis, Gracillia perseae, Haematobia irritans, Hypoderma lineatum, Liriomyza brassicae, Liriomyza sativa, Melophagus ovinus, Musca autumnalis, Musca domestica, Oestrus ovis, Oscinella frit, Pegomya betae, Piophila casei, Psila rosae, Rhagoletis cerasi, Rhagoletis pomonella, Rhagoletis mendax, Sitodiplosis mosellana, and Stomoxys calcitrans.

(8) Order Hemiptera. A non-exhaustive list of particular genera includes, but is not limited to, Adelges spp., Aulacaspis spp., Aphrophora spp., Aphis spp., Bemisia spp., Ceroplastes spp., Chionaspis spp., Chrysomphalus spp., Coccus spp., Empoasca spp., Euschistus spp., Lepidosaphes spp., Lagynotomus spp., Lygus spp., Macrosiphum spp., Nephotettix spp., Nezara spp., Nilaparvata spp., Philaenus spp., Phytocoris spp., Piezodorus spp., Planococcus spp., Pseudococcus spp., Rhopalosiphum spp., Saissetia spp., Therioaphis spp., Toumeyella spp., Toxoptera spp., Trialeurodes spp., Triatoma spp., and Unaspis spp. A non-exhaustive list of particular species includes, but is not limited to, Acrosternum hilare, Acyrthosiphon pisum, Aleyrodes proletella, Aleurodicus dispersus, Aleurothrixus floccosus, Amrasca biguttula biguttula, Aonidiella aurantii, Aphis fabae, Aphis gossypii, Aphis glycines, Aphis pomi, Aulacorthum solani, Bactericera cockerelli, Bagrada hilaris, Bemisia argentifolii, Bemisia tabaci, Blissus leucopterus, Boisea trivittata, Brachycorynella asparagi, Brevennia rehi, Brevicoryne brassicae, Cacopsylla pyri, Cacopsylla pyricola, Calocoris norvegicus, Ceroplastes rubens, Cimex hemipterus, Cimex lectularius, Coccus pseudomagnoliarum, Dagbertus fasciatus, Dichelops furcatus, Diuraphis noxia, Diaphorina citri, Dysaphis plantaginea, Dysdercus suturellus, Edessa meditabunda, Empoasca vitis, Eriosoma lanigerum, Erythroneura elegantula, Eurygaster maura, Euschistus conspersus, Euschistus heros, Euschistus servus, Halyomorpha halys, Helopeltis antonii, Hyalopterus pruni, Helopeltis antonii, Helopeltis theivora, Icerya purchasi, Idioscopus nitidulus, Jacobiasca formosana, Laodelphax striatellus, Lecanium corni, Leptocorisa oratorius, Leptocorisa varicornis, Lygus hesperus, Maconellicoccus hirsutus, Macrosiphum euphorbiae, Macrosiphum granarium, Macrosiphum rosae, Macrosteles quadrilineatus, Mahanarva frimbiolata, Megacopta cribraria, Metopolophium dirhodum, Mictis longicornis, Myzus persicae, Nasonovia ribisnigri, Nephotettix cincticeps, Neurocolpus longirostris, Nezara viridula, Nilaparvata lugens, Paracoccus marginatus, Paratrioza cockerelli, Parlatoria pergandii, Parlatoria ziziphi, Peregrinus maidis, Phylloxera vitifoliae, Physokermes piceae, Phytocoris californicus, Phytocoris relativus, Piezodorus guildinii, Planococcus citri, Planococcus ficus, Poecilocapsus lineatus, Psallus vaccinicola, Pseudacysta perseae, Pseudococcus brevipes, Quadraspidiotus perniciosus, Rhopalosiphum maidis, Rhopalosiphum padi, Saissetia oleae, Scaptocoris castanea, Schizaphis graminum, Sitobion avenae, Sogatella furcifera, Trialeurodes vaporariorum, Trialeurodes abutiloneus, Unaspis yanonensis, and Zulia entrerriana.

(9) Order Hymenoptera. A non-exhaustive list of particular genera includes, but is not limited to, Acromyrmex spp., Atta spp., Camponotus spp., Diprion spp., Dolichovespula spp., Formica spp., Monomorium spp., Neodiprion spp., Paratrechina spp., Pheidole spp., Pogonomyrmex spp., Polistes spp., Solenopsis spp., Technomyrmex, spp., Tetramorium spp., Vespula spp., Vespa spp., and Xylocopa spp. A non-exhaustive list of particular species includes, but is not limited to, Athalia rosae, Atta texana, Caliroa cerasi, Cimbex americana, Iridomyrmex humilis, Linepithema humile, Mellifera Scutellata, Monomorium minimum, Monomorium pharaonis, Neodiprion sertifer, Solenopsis invicta, Solenopsis geminata, Solenopsis molesta, Solenopsis richtery, Solenopsis xyloni, Tapinoma sessile, and Wasmannia auropunctata.

(10) Order Isoptera. A non-exhaustive list of particular genera includes, but is not limited to, Coptotermes spp., Cornitermes spp., Cryptotermes spp., Heterotermes spp., Kalotermes spp., Incisitermes spp., Macrotermes spp., Marginitermes spp., Microcerotermes spp., Procornitermes spp., Reticulitermes spp., Schedorhinotermes spp., and Zootermopsis spp. A non-exhaustive list of particular species includes, but is not limited to, Coptotermes acinaciformis, Coptotermes curvignathus, Coptotermes frenchi, Coptotermes formosanus, Coptotermes gestroi, Cryptotermes brevis, Heterotermes aureus, Heterotermes tenuis, Incisitermes minor, Incisitermes snyderi, Microtermes obesi, Nasutitermes corniger, Odontotermes formosanus, Odontotermes obesus, Reticulitermes banyulensis, Reticulitermes grassei, Reticulitermes flavipes, Reticulitermes hageni, Reticulitermes hesperus, Reticulitermes santonensis, Reticulitermes speratus, Reticulitermes tibialis, and Reticulitermes virginicus.

(11) Order Lepidoptera. A non-exhaustive list of particular genera includes, but is not limited to, Adoxophyes spp., Agrotis spp., Argyrotaenia spp., Cacoecia spp., Caloptilia spp., Chilo spp., Chrysodeixis spp., Colias spp., Crambus spp., Diaphania spp., Diatraea spp., Earias spp., Ephestia spp., Epimecis spp., Feltia spp., Gortyna spp., Helicoverpa spp., Heliothis spp., Indarbela spp., Lithocolletis spp., Loxagrotis spp., Malacosoma spp., Nemapogon spp., Peridroma spp., Phyllonorycter spp., Pseudaletia spp., Plutella spp., Sesamia spp., Spodoptera spp., Synanthedon spp., and Yponomeuta spp. A non-exhaustive list of particular species includes, but is not limited to, Achaea janata, Adoxophyes orana, Agrotis ipsilon, Alabama argillacea, Amorbia cuneana, Amyelois transitella, Anacamptodes defectaria, Anarsia lineatella, Anomis sabulifera, Anticarsia gemmatalis, Archips argyrospila, Archips rosana, Argyrotaenia citrana, Autographa gamma, Bonagota cranaodes, Borbo cinnara, Bucculatrix thurberiella, Capua reticulana, Carposina niponensis, Chlumetia transversa, Choristoneura rosaceana, Cnaphalocrocis medinalis, Conopomorpha cramerella, Corcyra cephalonica, Cossus cossus, Cydia caryana, Cydia funebrana, Cydia molesta, Cydia nigricana, Cydia pomonella, Darna diducta, Diaphania nitidalis, Diatraea saccharalis, Diatraea grandiosella, Earias insulana, Earias vittella, Ecdytolopha aurantianum, Elasmopalpus lignosellus, Ephestia cautella, Ephestia elutella, Ephestia kuehniella, Epinotia aporema, Epiphyas postvittana, Erionota thrax, Estigmene acrea, Eupoecilia ambiguella, Euxoa auxiliaris, Galleria mellonella, Grapholita molesta, Hedylepta indicata, Helicoverpa armigera, Helicoverpa zea, Heliothis virescens, Hellula undalis, Keiferia lycopersicella, Leucinodes orbonalis, Leucoptera coffeella, Leucoptera malifoliella, Lobesia botrana, Loxagrotis albicosta, Lymantria dispar, Lyonetia clerkella, Mahasena corbetti, Mamestra brassicae, Manduca sexta, Maruca testulalis, Metisa plana, Mythimna unipuncta, Neoleucinodes elegantalis, Nymphula depunctalis, Operophtera brumata, Ostrinia nubilalis, Oxydia vesulia, Pandemis cerasana, Pandemis heparana, Papilio demodocus, Pectinophora gossypiella, Peridroma saucia, Perileucoptera coffeella, Phthorimaea operculella, Phyllocnistis citrella, Phyllonorycter blancardella, Pieris rapae, Plathypena scabra, Platynota idaeusalis, Plodia interpunctella, Plutella xylostella, Polychrosis viteana, Prays endocarpa, Prays oleae, Pseudaletia unipuncta, Pseudoplusia includens, Rachiplusia nu, Scirpophaga incertulas, Sesamia inferens, Sesamia nonagrioides, Setora nitens, Sitotroga cerealella, Sparganothis pilleriana, Spodoptera exigua, Spodoptera frugiperda, Spodoptera eridania, Thecla basilides, Tinea pellionella, Tineola bisselliella, Trichoplusia ni, Tuta absoluta, Zeuzera coffee, and Zeuzea pyrina.

(12) Order Mallophaga. A non-exhaustive list of particular genera includes, but is not limited to, Anaticola spp., Bovicola spp., Chelopistes spp., Goniodes spp., Menacanthus spp., and Trichodectes spp. A non-exhaustive list of particular species includes, but is not limited to, Bovicola bovis, Bovicola caprae, Bovicola ovis, Chelopistes meleagridis, Goniodes dissimilis, Goniodes gigas, Menacanthus stramineus, Menopon gallinae, and Trichodectes canis.

(13) Order Orthoptera. A non-exhaustive list of particular genera includes, but is not limited to, Melanoplus spp. and Pterophylla spp. A non-exhaustive list of particular species includes, but is not limited to, Acheta domesticus, Anabrus simplex, Gryllotalpa africana, Gryllotalpa australis, Gryllotalpa brachyptera, Gryllotalpa hexadactyla, Locusta migratoria, Microcentrum retinerve, Schistocerca gregaria, and Scudderia furcata.

(14) Order Psocoptera. A non-exhaustive list of particular species includes, but is not limited to, Liposcelis decolor, Liposcelis entomophila, Lachesilla quercus, and Trogium pulsatorium.

(15) Order Siphonaptera. A non-exhaustive list of particular species includes, but is not limited to, Ceratophyllus gallinae, Ceratophyllus niger, Ctenocephalides canis, Ctenocephalides felis, and Pulex irritans.

(16) Order Thysanoptera. A non-exhaustive list of particular genera includes, but is not limited to, Caliothrips spp., Frankliniella spp., Scirtothrips spp., and Thrips spp. A non-exhaustive list of particular species includes, but is not limited to, Caliothrips phaseoli, Frankliniella bispinosa, Frankliniella fusca, Frankliniella occidentalis, Frankliniella schultzei, Frankliniella tritici, Frankliniella williamsi, Heliothrips haemorrhoidalis, Rhipiphorothrips cruentatus, Scirtothrips citri, Scirtothrips dorsalis, Taeniothrips rhopalantennalis, Thrips hawaiiensis, Thrips nigropilosus, Thrips orientalis, Thrips palmi, and Thrips tabaci.

(17) Order Thysanura. A non-exhaustive list of particular genera includes, but is not limited to, Lepisma spp. and Thermobia spp.

(18) Order Acarina. A non-exhaustive list of particular genera includes, but is not limited to, Acarus spp., Aculops spp., Argus spp., Boophilus spp., Demodex spp., Dermacentor spp., Epitrimerus spp., Eriophyes spp., Ixodes spp., Oligonychus spp., Panonychus spp., Rhizoglyphus spp., and Tetranychus spp. A non-exhaustive list of particular species includes, but is not limited to, Acarapis woodi, Acarus siro, Aceria mangiferae, Aculops lycopersici, Aculus pelekassi, Aculus schlechtendali, Amblyomma americanum, Brevipalpus obovatus, Brevipalpus phoenicis, Dermacentor variabilis, Dermatophagoides pteronyssinus, Eotetranychus carpini, Liponyssoides sanguineus, Notoedres cati, Oligonychus coffeae, Oligonychus ilicis, Ornithonyssus bacoti, Panonychus citri, Panonychus ulmi, Phyllocoptruta oleivora, Polyphagotarsonemus latus, Rhipicephalus sanguineus, Sarcoptes scabiei, Tegolophus perseaflorae, Tetranychus urticae, Tyrophagus longior, and Varroa destructor.

(19) Order Araneae. A non-exhaustive list of particular genera includes, but is not limited to, Loxosceles spp., Latrodectus spp., and Atrax spp. A non-exhaustive list of particular species includes, but is not limited to, Loxosceles reclusa, Latrodectus mactans, and Atrax robustus.

(20) Class Symphyla. A non-exhaustive list of particular species includes, but is not limited to, Scutigerella immaculata.

(21) Subclass Collembola. A non-exhaustive list of particular species includes, but is not limited to, Bourletiella hortensis, Onychiurus armatus, Onychiurus fimetarius, and Sminthurus viridis.

(22) Phylum Nematoda. A non-exhaustive list of particular genera includes, but is not limited to, Aphelenchoides spp., Belonolaimus spp., Criconemella spp., Ditylenchus spp., Globodera spp., Heterodera spp., Hirschmanniella spp., Hoplolaimus spp., Meloidogyne spp., Pratylenchus spp., and Radopholus spp. A non-exhaustive list of particular species includes, but is not limited to, Dirofilaria immitis, Globodera pallida, Heterodera glycines, Heterodera zeae, Meloidogyne incognita, Meloidogyne javanica, Onchocerca volvulus, Pratylenchus penetrans, Radopholus similis, and Rotylenchulus reniformis.

(23) Phylum Mollusca. A non-exhaustive list of particular species includes, but is not limited to, Arion vulgaris, Cornu aspersum, Deroceras reticulatum, Limax flavus, Milax gagates, and Pomacea canaliculata.

In one aspect, the pest group to control is sap-feeding pests. Sap-feeding pests, in general, have piercing and/or sucking mouthparts and feed on the sap and inner plant tissues of plants. Examples of sap-feeding pests of particular concern to agriculture include, but are not limited to, aphids, leafhoppers, moths, scales, thrips, psyllids, mealybugs, stinkbugs, and whiteflies. Specific examples of Orders that have sap-feeding pests of concern in agriculture include but are not limited to, Anoplura and Hemiptera. Specific examples of Hemiptera that are of concern in agriculture include, but are not limited to, Aulacaspis spp., Aphrophora spp., Aphis spp., Bemisia spp., Coccus spp., Euschistus spp., Lygus spp., Macrosiphum spp., Nezara spp., and Rhopalosiphum spp.

In another aspect, the pest group to control is chewing pests. Chewing pests, in general, have mouthparts that allow them to chew on the plant tissue including roots, stems, leaves, buds, and reproductive tissues (including, but not limited to flowers, fruit, and seeds). Examples of chewing pests of particular concern to agriculture include, but are not limited to, caterpillars, beetles, grasshoppers, and locusts. Specific examples of Orders that have chewing pests of concern in agriculture include but are not limited to, Coleoptera and Lepidoptera. Specific examples of Coleoptera that are of concern in agriculture include, but are not limited to, Anthonomus spp., Cerotoma spp., Chaetocnema spp., Colaspis spp., Cyclocephala spp., Diabrotica spp., Hypera spp., Phyllophaga spp., Phyllotreta spp., Sphenophorus spp., Sitophilus spp.

In an embodiment, the agriculturally suitable carrier comprises a seed or seed coat (“seed-based carrier”). As will be understood by those of skill in the art, a seed-based carrier composition may comprise a single seed or multiple seeds. In an embodiment, the encysted or sporulated protozoa may be present directly on the seed-based carrier, or may be present in a formulation layered over the seed-based carrier (i.e.: “encapsulated seeds”). In an embodiment, the formulation layered over the seed-based carrier may comprise or consist of granular materials, liquid slurries, biopolymers (such as biopolymer gels), and liquid suspensions. Such formulations may comprise organic materials, inorganic materials, or materials synthesized from specific molecules. Dry carriers can be produced using different kinds of soil materials (peat, coal, clays, inorganic soil), organic materials (composts, soybean meal, wheat bran, sawdust, etc.), or inert materials (e.g., vermiculite, perlite, kaolin, bentonite, silicates). Liquid carriers can be based on broth cultures, mineral or organic oils, or on oil-in-water suspensions. In the case of solid carriers, powder, granules, or beads can be used. Any other materials suitable for encapsulating seeds may also be used with the carriers of the present invention.

Such formulations may further comprise any other materials as deemed suitable for an intended use of the composition, including but not limited to polymers, bulking agents, and any other suitable component. In various non-limiting examples, powders can be used to coat seed-based carriers, or can be suspended in a liquid to form a slurry that is directly applied to the seed-based carrier, using standard techniques in the art.

In an embodiment, the agriculturally suitable carrier comprises a granular carrier, liquid slurry carrier, liquid suspension carrier (“non-seed based carrier”), or a combination thereof, and the encysted protozoa are present on or in the carrier. Such carriers may include organic materials, inorganic materials, materials synthesized from specific molecules, or a combination thereof. Dry carriers can be produced using different kinds of soil materials (peat, coal, clays, inorganic soil), organic materials (composts, soybean meal, wheat bran, sawdust, etc.), inert materials (e.g., vermiculite, perlite, kaolin, bentonite, silicates), or a combination thereof. Liquid carriers can be based on broth cultures, mineral or organic oils, on oil-in-water suspensions, or a combination thereof. In the case of solid carriers, powder, granules, or beads can be used. In an embodiment, the encysted protozoa may be present directly on the non-seed based carrier, or may be present within the volume of the non-seed based carrier, which may further include any other materials as deemed suitable for an intended use of the composition, including but not limited to polymers, bulking agents, and any other suitable component.

The carrier preferably has a sufficient shelf life, and preferably allows an easy dispersion or dissolution in the volume of soil near the root system. A preferred carrier would thus have one or more properties including good moisture absorption capacity, easy to process and free of lump-forming materials, near-sterile or easy to sterilize by autoclaving or by other methods (e.g., gamma-irradiation), and good pH buffering capacity. For carriers that are used for seed coating, good adhesion to seeds is preferable.

Many protozoans respond to adverse environmental conditions by encystment or sporulation. For example, encysting, which involves secretion of a thick wall (‘cyst”) surrounding the protozoan and effectively entering a resistant dormant state. Such adverse environmental conditions include, but are not limited to, changes in temperature, aquatic acidity, food supply, moisture, and light. Protozoans will typically jettison partially-digested food particles in food vacuoles prior to encystations. When the environment is once again suitable for the protozoan, the cyst wall breaks down, a process known as excystation. Sporulation is another mechanism some protozoa use for responding to adverse environmental conditions. Inducing protozoan encystment or sporulation is well within the level of skill in the art, and the techniques used to do so will depend on the protozoan species to encyst or sporulate. Exemplary means to induce protozoan encystment or sporulation include, but are not limited to, gently drying a liquid culture or by depletion of the food supply.

The encysted or sporulated protozoa are present on or in the agriculturally suitable carrier. The encysted or sporulated protozoa for use in the present invention are those which are motile when not in an encysted or sporulated state. In use the compositions are placed in soil where a plant is growing (non-seed based carriers), or to soil where a seed is to be planted (seed-based carrier) or a plant is to be planted (non-seed-based carriers). After placement of the composition with appropriate encysted or sporulated protozoan in the soil, the protozoa will remain encysted or sporulated until soil conditions are suitable for the protozoan to emerge. Suitable conditions include adequate moisture, appropriate temperature, proximity of a root tip (though not required), or any combinations thereof. Protozoans emerge from cysts as a direct response to proximity to a growing root tip. Once protozoans emerge, they feed upon bacteria-sized particles in their vicinity. Protozoans are capable of actively transporting these particles a distance equal to the motility rate of the protozoan times the residence time of particles contained within or attached along the exterior surface of the protozoan. As shown in the examples that follow, such active transport of agricultural payloads (such as agrochemicals with or without a food source for protozoa such as an agriculturally nonbeneficial bacteria) is much more rapid than would be seen in the absence of active transport via the protozoan carriers.

In an embodiment, the composition includes an agricultural payload. As used herein, “agricultural payload” is any suitable component that can be transported to the growing roots of a plant via the compositions of the invention, and which can provide a benefit to the plant. Any such suitable agricultural payload can be delivered, including but not limited to a food source for protozoa such as an agriculturally nonbeneficial bacteria, agrochemicals such as insecticides and pesticides, nanoparticles or nanoparticles aggregates, or a combination thereof, either distributed individually or contained in or on a bacteria-sized carrier, and micro-sized pellets or capsules including liposomes or polymerosomes containing any compound currently used in corporate agriculture. Examples include fertilizers or other plant nutrients (i.e., bioavailable nitrogen or phosphorous), pesticides especially nematicides, fungicides, or bactericides effective against pathogenic bacteria.

In an embodiment, the agricultural payload includes a food source for protozoa such as an agriculturally nonbeneficial bacteria and an agrochemical. In an embodiment, the agricultural payload includes a food source for protozoa such as an agriculturally nonbeneficial bacteria and an agrochemical/s such as insecticide/s, pesticide/s, or a combination thereof. In an embodiment, the agricultural payload includes an agrochemical/s such as a herbicides, fungicides, insecticides, nematicides, or a combination thereof. In an embodiment, the food source for protozoa is a soil bacterium. In an embodiment, the food source for protozoa is an agriculturally nonbeneficial bacteria. In an embodiment, the agrochemical is herbicides, fungicides, insecticides, nematicides, or a combination thereof. In an embodiment, the agrochemical is an insecticide/s. In an embodiment, the agrochemical is a pesticide/s.

The food source for protozoa such as an agriculturally nonbeneficial bacteria can be directly coated on the encysted or sporulated protozoa (for example, co-locating bacteria immobilized at high concentrations in a formulation, such as a biopolymer gel with encysted protozoans; see, for example, Journal of Industrial Microbiology February 1996, 16 (2): 79-101); for example, this embodiment facilitates ingestion of agriculturally nonbeneficial bacteria by the protozoa following release from dormancy after placement of the compositions for use in promoting plant growth. Alternatively, the bacteria may be present dispersed within the non-seed carrier and/or formulation as appropriate for a given composition. The composition may include any suitable agriculturally nonbeneficial bacteria as a food source for protozoa, a nonlimiting example of such agriculturally nonbeneficial bacteria is Bacillus subtilis, any suitable agriculturally nonbeneficial bacteria can be used. The composition may comprise any suitable amount of agriculturally nonbeneficial bacteria as suitable for a given purpose (food source for protozoa). In an embodiment where the bacteria are dispersed in a formulation, the compositions would preferably have at least 50,000 bacteria; preferably at least 100,000, 250,000; 500,000, or more bacteria per seed. In an embodiment where the bacteria are present on the protozoa, the bacteria can be present at 10 bacteria or more per protozoan. In an embodiment at least 25, 50, 75, 100, or more bacteria per protozoan.

Any suitable ratio of protozoa to agriculturally nonbeneficial bacteria can be present in the bacteria-containing compositions of the invention. The specific ratio to use in a composition will depend on all variables, including but not limited to the vehicle to be used, the plant to be treated with the composition, the protozoa and bacteria to be used, used, the soil type, soil moisture etc. In one non-limiting embodiment, the protozoa: bacteria in the composition is between about 1:50 to 1:10,000. For example, the ratio is between about 1:50 to 1:5000, 1:50 to 1:2500, 1:50 to 1:1000, 1:50 to 1:500, 1:100 to 1:10,000, 1:250 to 1:10,000, 1:500 to 1:10,000, 1:1000 to 1:10,000, 1:100 to 1:5000, 1:100 to 2500, 1:100 to 1:1000, 1:250 to 1:10,000, 1:250 to 1:5000, 1:250 to 1:2500, 1:500 to 1:10,000, 1:500 to 1:5000, and about 1:1000 to 1:10,000.

The composition of any embodiment or combination of embodiments of the invention may further comprise an outer coating, to provide improved structural integrity of the composition, which is particularly advantageous for improving storage life of the compositions of the invention, or for selective breakdown of the coating material once a certain temperature or moisture condition suitable for germination is achieved. Any suitable coating can be used; the specific coating to be used will depend on all specifics of the particular composition on which the outer coat is to be placed. Exemplary coatings include, but are not limited to, loam, starch, tyllose (cellulose derivative) or polyacrylate/polyacrylamide polymers, lime, diatomaceous earth, calcium carbonate, talc, silica, kaolin-clay, zeolite, bentonite, vermiculite, proprietary polymers, and combinations thereof. The coatings may comprise any other suitable components, such as binders. Such binders may include, but are not limited to, starch, polyvinyl alcohol, carboxymethyl cellulose, methyl cellulose, and gelatin. It is well within the level of skill in the art to determine an appropriate outer coating for a particular composition of the invention, based on the teachings of the present application.

The inventors of the present invention have unexpectedly discovered that the compositions of the present invention can be used, for example, to promote significantly improved transport and dispersal of the agricultural payloads such as agrochemicals with or without the food source for protozoa such as an agriculturally nonbeneficial bacteria to vulnerable root tips of actively growing plants by active transport via protozoan carriers than would be possible in the absence of the protozoan carriers. This discovery enables various inventions as described herein.

In an aspect, the present invention provides methods for improved plant growth, including delivering the composition of any embodiment or combination of embodiments of the invention to soil with an existing plant, or to soil where a plant or seed is to be planted. In an embodiment, the compositions for use in the methods of the invention include an agricultural payload, such as a food source for protozoa such as an agriculturally nonbeneficial bacteria, agriculturally beneficial bacteria, an agrochemical, or a combination thereof. In an embodiment, the compositions for use in the methods of the invention comprise an agricultural payload including a protist and an agrochemical.

In an aspect, a modified plant seed is provided, including a plant seed and an agrochemical composition as described herein, in some embodiments, the composition is coated on at least part of the plant seed, and in some embodiments, the composition fully coats the seed. In some embodiments, the modified plant seed includes one or more of alfalfa, almonds, apples, barley, beans, canola, corn, cotton, crucifers, flowers, fodder species, fruits, lettuce, oats, oil seed crops, oranges, peanuts, pears, peppers, potatoes, rice, sorghum, soybeans, strawberries, sugarcane, sugar beets, sunflowers, tobacco, tomatoes, and wheat, and in some embodiments, the modified plant seed is alfalfa, almonds, apples, barley, beans, canola, corn, cotton, crucifers, flowers, fodder species, fruits, lettuce, oats, oil seed crops, oranges, peanuts, pears, peppers, potatoes, rice, sorghum, soybeans, strawberries, sugarcane, sugar beets, sunflowers, tobacco, tomatoes, or wheat.

In an aspect, the disclosure provides a method for treating a plant seed, the method including coating at least part of a plant seed with an agrochemical composition as described herein. In another aspect, a method is provided including administering a agrochemical composition described herein to soil with an existing seed or plant, to soil where a plant or seed is to be planted, or to a seed or plant prior to planting, in which the method reduces plant loss to pests. In some embodiments, the pest is selected from Phyla Arthropoda, Mollusca, or Nematoda 12.

In another aspect, a method is provided including the step of applying an agrochemical composition described herein to a medium where a crop plant is growing, to a seed or to a seed coating, in which the method controls or eliminates a pest infestation of the crop plant. In embodiments, the medium where the crop plant is growing is soil.

In embodiments where the carrier is a seed-based carrier, the methods may include delivering the composition to soil where the seed is to be planted. In embodiments where the carrier comprises a non-seed based carrier, the methods may comprise administering the composition to soil with an existing seed or plant. Other suitable uses of the compositions in the methods of the invention will be apparent to those of skill in the art based on the teachings herein. In an embodiment, seeds are coated with encysted or sporulated protozoa and are co-located with an agrochemical in a formulation (such as a biopolymer gel) coated over the seed. In an embodiment, seeds are coated with encysted or sporulated protozoa and are co-located with agrochemical with or without the food source for protozoa such as an agriculturally nonbeneficial bacteria in a formulation (such as a biopolymer gel) coated over the seed. The seeds are then planted and, as the seeds germinate and first roots form, the encysted or sporulated protist senses proximity to a growing root, excysts (or otherwise exits dormancy), and immediately begin seeking prey. The agrochemical with or without the food source for protozoa such as an agriculturally nonbeneficial bacteria and/or agriculturally beneficial bacteria may be transported by protozoans either by engulfing/ingesting or by carriage on exterior protist surfaces. As the early plant develops, the protozoa transport the agrochemical along the rapidly growing plant roots.

In an embodiment, a non-seed based carrier composition includes encysted or sporulated protozoa and are co-located with an agrochemical immobilized in a formulation (such as a biopolymer gel) coated over the non-seed based carrier. In an embodiment, a non-seed based carrier composition includes encysted or sporulated protozoa and are co-located with an agrochemical with or without a food source for protozoa such as an agriculturally nonbeneficial bacteria and immobilized in a formulation (such as a biopolymer gel) coated over the non-seed based carrier. The compositions are then delivered to a site where a seed is to be planted or has already been planted, as the seeds germinate and first roots form, the protist excysts (or otherwise exits dormancy) and the resulting motile protozoa transport (for example, by engulfing/ingesting) an agrochemical with or without a food source for protozoa such as an agriculturally nonbeneficial bacteria in the composition and are thus able to transport them as described above.

### Enumerated Embodiments

Embodiment I. An agrochemical composition, comprising (i.) an agriculturally suitable carrier; (ii.) at least one encysted or sporulated protozoa (protist); and (iii.) an agricultural payload, comprising an agrochemical.

Embodiment II. The agrochemical composition of embodiment I, further comprising a food source for the protist.

Embodiment III. The agrochemical composition of either one of embodiments I or II, wherein the food source is bacteria.

Embodiment IV. The agrochemical composition of any one of embodiments I to III, wherein the agriculturally suitable carrier comprises a seed-based carrier or comprises a non-seed-based carrier.

Embodiment V. The agrochemical composition of any one of embodiments I to IV, wherein the seed-based carrier comprises a plant seed coated with the encysted or sporulated protist and agricultural payload of Embodiment 1, and the non-seed-based carrier comprises a granular carrier, a liquid slurry carrier, a liquid suspension carrier, or a combination thereof.

Embodiment VI. The agrochemical composition of any one of embodiments I to V, wherein the agrochemical comprises one or more of an insecticide, a nematicide, and a fungicide, each, if present, with a water solubility of less than about 50 ppm and log K_{ow} higher than about 2.5.

Embodiment VII. The agrochemical composition of any one of embodiments I to VI, wherein the soil protist is a phagotrophic soil protist.

Embodiment VIII. The agrochemical composition of embodiment VII, wherein the soil protist is selected from the group consisting of Colpoda sp., Amoeba sp., flagellates, ciliates, cercozoans, rhizaria, testate amoebae, heliozoan, and euglenoids.

Embodiment IX. The agrochemical composition of any one of embodiments I to VIII, wherein the agrochemical comprises an insecticide.

Embodiment X. The agrochemical composition of any one of embodiments I to IX, wherein the agrochemical comprises a nematicide.

Embodiment XI. The agrochemical composition of any one of embodiments I to X, wherein the agrochemical comprises a fungicide.

Embodiment XII. The agrochemical composition of embodiment IX, wherein the insecticide comprises chlorantraniliprole or cyantraniliprole.

Embodiment XIII. The agrochemical composition of embodiment IX, wherein the insecticide is chlorantraniliprole or spinosad.

Embodiment XIV. A modified plant seed, comprising: (i.) a plant seed; and (ii.) the agrochemical composition of any one of embodiments I to XIII, wherein the composition is coated on at least part of the plant seed.

Embodiment XV. The modified plant seed of embodiment XIV, wherein the plant seed selected from the group consisting of alfalfa, almonds, apples, barley, beans, canola, corn, cotton, crucifers, flowers, fodder species, fruits, lettuce, oats, oil seed crops, oranges, peanuts, pears, peppers, potatoes, rice, sorghum, soybeans, strawberries, sugarcane, sugar beets, sunflowers, tobacco, tomatoes, and wheat.

Embodiment XVI. A method for treating a plant seed, comprising coating at least part of a plant seed with the agrochemical composition of any one of embodiments I to XIII.

Embodiment XVII. A method, comprising administering the composition of any one of embodiments I to XIII to soil with an existing seed or plant, to soil where a plant or seed is to be planted, or to a seed or plant prior to planting, wherein the method reduces plant loss to pests.

Embodiment XVIII. The method of embodiment 17, wherein the pest is selected from Phyla Arthropoda, Mollusca, or Nematoda 12.

Embodiment XIX. A method, comprising the step of applying the agrochemical composition of any one of embodiments I to XIII to a medium where a crop plant is growing, to a seed or to a seed coating, wherein the method controls or eliminates a pest infestation of the crop plant.

Embodiment XX. The method of embodiment XIX, wherein the medium where the crop plant is growing is soil.

Embodiment XXI. A method for improved plant growth, comprising administering the composition of any one of embodiments I to XIII to soil with an existing seed or plant, to soil where a plant or seed is to be planted, or to a seed or plant prior to planting.

The present disclosure is illustrated and further described in more detail with reference to the following non-limiting examples. Section headings as used in this section and the entire disclosure herein are merely for organizational purposes and are not intended to be limiting.

### EXAMPLES

An aim of the work performed in the examples (and associated methods) described below was to evaluate and measure the systemic effects on pest damage resistance for plants grown from seeds treated with insecticides plus soil protists versus similar plants treated with insecticides alone. The examples below demonstrate that the addition of protists to a seed treatment with agrochemicals Chlorantraniliprole or Spinosad can improve both the protection provided by, and the duration for which the agrochemical offers protection to the plant. The examples further demonstrate, inter alia, that protists enable active transport of agrochemicals throughout the root network, which enhances the protection offered by the exemplary agrochemicals utilized herein.

### Example 1: Effects of Soil Protists on Pest Damage Resistance-Methodology

An experiment was designed to measure any systemic effects of soil protists in the presence and absence of (agrochemical) insecticide on pest damage resistance for plants grown from seeds. The experiments consisted of two stages: the growth stage and the pest stage. In the growth stage, maize seeds were treated individually with one of six mixtures containing bacteria, protists, and or/agrochemicals. All treatments included heat-killed bacteria, the food source for protists (protozoa). Additional potential components of each treatment were one of two agrochemicals, or soil protists, or one of two agrochemicals plus soil protists (Table 1). Treated seeds were germinated and grown in soil-filled pots in a greenhouse. Plants were grown in surplus quantities and down-selected to 48 representative plants per treatment for each experimental run (Table 2).

TABLE 1
Experimental treatments are defined by the composition of additives
applied to the seed at the growth stage. Seed treatment components
are expressed on a per plant (single seed) basis.

| Experimental | Constituents Added to Seed | | |
|---|---|---|---|
| Treatment | Bacteria | Protists | Agrochemical |
| Baseline | 6 × 10⁷ | — | — |
| Protists | 6 × 10⁷ | 5 × 10⁴ | — |
| Chlorantraniliprole | 6 × 10⁷ | — | 0.5 μg Chlorantraniliprole |
| Chlorantraniliprole + | 6 × 10⁷ | 5 × 10⁴ | 0.5 μg Chlorantraniliprole |
| Protists | | | |
| Spinosad | 6 × 10⁷ | — | 167 μg Spinosad |
| Spinosad + Protists | 6 × 10⁷ | 5 × 10⁴ | 167 μg Spinosad |

In the pest stage, three individual leaves were harvested from each plant, then the Tip and Middle segments of said leaves were collected. Each of the six leaf segments from the plant were placed in individual tray wells and challenged by a single insect larva, as explained further below.

TABLE 2
Experimental design showing the number of plants harvested per treatments per experimental run.
From each harvested plant, six leaf segments were challenged individually in the pest stage
for a total of 5,750 segments (i.e., 960 plants x six segments per plant) tested overall.

| | Treatment | | | | | | |
|---|---|---|---|---|---|---|---|
| | | | | Chloran- | | | |
| Experimental | | | Chloran- | traniliprole + | | Spinosad + | Sampled |
| Run | Baseline | Protists | traniliprole | Protists | Spinosad | Protists | Plants |
| 1 | 48 | 48 | 48 | 48 | — | — | 192 |
| 2 | 48 | 48 | 48 | 48 | — | — | 192 |
| 3 | 48 | 48 | 48 | 48 | — | — | 192 |
| 4 | 48 | 48 | — | — | 48 | 48 | 192 |
| 5 | 48 | 48 | — | — | 48 | 48 | 192 |
| Total Plants | 240 | 240 | 144 | 96 | 144 | 96 | 960 |

### Example 2: Effects of Soil Protists on Pest Damage Resistance-Biological Materials and Methods

Bacteria were used to feed and propagate soil protists, as described previously (Hawxhurst CJ, et al., 2023). Briefly, E. coli DH5a was grown to stationary phase in Luria broth (LB) before being washed three times and resuspended in Page's Saline. Concentration of the E. coli stock solution was taken using OD₆₀₀ measured in a 100 μL suspension in a 96-well microtiter plate and were used to calculate the amount of stock solution to feed to the protists. E. coli stock was then heat killed at 95° C. for 1 h before use in seed treatments or to propagate protists.

Protists were identified by 18S rRNA gene sequencing as belonging to a ciliate genus, Colpoda, which is classified as “UC-1” (Taerum S J, et al . . . 2020. Validation of a PNA Clamping Method for Reducing Host DNA Amplification and Increasing Eukaryotic Diversity in Rhizosphere Microbiome Studies. Phytobiomes J⋅2020⋅4:291-302), and were passaged from cultures originally isolated from soil. UC-1 cultures were maintained by removing encysted protists from culture flask surfaces and passaging half an existing culture into 50 mL fresh Page's Saline in a 175 cm² culture flask. Protists were fed heat-killed E. coli DH5a which was added twice a week to a final OD₆₀₀=0.025 (total feeding OD₆₀₀=0.050 per week), measured as described above. Protists were concentrated and prepared for experimentation following methods for trophozoites previously described (Hawxhurst C J, et al., 2023).

Spodoptera frugiperda, commonly “Fall armyworm” (FAW) (Lepidoptera: Noctuidae, JE Smith, 1797) are among the Food and Agriculture Organization of the United Nations top 10 global pests. FAW larva cause crop damage by consuming foliage. As of 2016, FAW have become established in Africa where they are expected to do nearly $10B annually in crop damage. In the southeastern United States, insecticides are often used to control FAW. But, as FAW larva feed deep within the whorl of young maize plants, foliar insecticides require high application rates to achieve adequate penetration. FAW larva were used in their first instar (growth stage) and were sourced from the insectary of Corteva Agriscience (Indianapolis, IN).

Corn (U.S.) or maize (U.K. and worldwide) (Zea mays L.) was chosen for demonstrating the technology because it is a fast-growing annual crop, an essential food staple, and has a huge global market. For this study a commercial hybrid was selected. Seeds were planted in excess so 48 representative plants of uniform size for each treatment could be selected prior to leaf harvest from 60 seeds initially started per treatment per experimental run.

### Example 3: Effects of Soil Protists on Pest Damage Resistance-Agrochemical Selection

Agrochemicals that are industrially important, commonly used, and also that have features that make them likely to benefit from co-application with soil protists were a focus of the experiments described herein. Thus, agrochemicals that are capable of plant phloem or xylem transport were considered in order to exhibit systemic (i.e., whole plant, versus localized) benefits from seed treatment or soil application. Also, agrochemicals with long soil half-lives >50 d were considered because these would remain effective during the main growth stage of commercially important annual crops without requiring re-treatment. Next, agrochemicals with a certain range of physiochemical properties were identified. When considering water-mediated transport, root-applied agrochemicals tend to be most effective when water solubility and hydrophobicity (i.e., log K_{ow}) are within a preferred range (Table 3). Agrochemicals less soluble and/or more hydrophobic than the preferred range tend to exhibit poor soil transmission via water infiltration and thus are more likely to exhibit protist-facilitated transport effects. Further, without wishing to be bound by this theory, it is reasoned that agrochemicals available in a particulate suspension may be most readily transported by ciliates given their particle-capturing feeding behavior. Finally, candidate formulations were screened for operational toxicity to UC-1 cultures (i.e., live protists in a concentrated formulation should remain viable and actively moving). Chlorantraniliprole and Spinosad satisfied all criteria and were selected for study. Both agrochemicals were used in their like-commercial formulations, which is a proprietary blend containing biocides and other ingredients needed to keep the agrochemical suspended and maintain performance.

TABLE 3
Physiochemical properties for water-based transport of agrochemicals
used in this study. Note Spinosad is a mix of two different
spinosoids (spinosyn A and spinosyn D).

| Physiochemical | Preferred | | |
|---|---|---|---|
| Property | Range | Chlorantraniliprole | Spinosad* |
| Water Solubility (ppm) | 50-600 | 2.5 | 2 |
| log K_{OW} | 0.75-2.5 | 721 | 3.2 |

*Values for Spinosad are those reported by Dow-Agriscience for the mixture.

### Example 4: Effects of Soil Protists on Pest Damage Resistance-Seed Treatment Formulations

The dosage of each insecticide employed (Table 1) was determined based on previous experimental results and was intended to exhibit a “break point,” or measurable reduction in protection, within the scope of the experiment for the agrochemical (alone) treatments (i.e., to show low feeding damage in Leaf 3 and higher feeding damage in Leaf 5 for the “Chlorantraniliprole” and for the “Spinosad” treatments). These dosages are lower than the typical therapeutic dosage and were selected to best show the effects, if any, of the addition of protists to the seed treatment on subsequent pest protection.

Formulations for seed treatments (Table 1) were prepared in Page's Saline 24 h prior to inoculation and held at 23° C. in darkness. Prior to application, each formulation was vortexed for 30 sec then a small aliquot (50 μL) was added directly on top of each exposed seed during planting. Based on our prior experience, this small-volume-aliquot performs similarly to more conventionally formulated seed coatings, enabling early-stage screening of experimental formulations that are available only in limited quantities.

### Example 5: Effects of Soil Protists on Pest Damage Resistance-Growth Stage

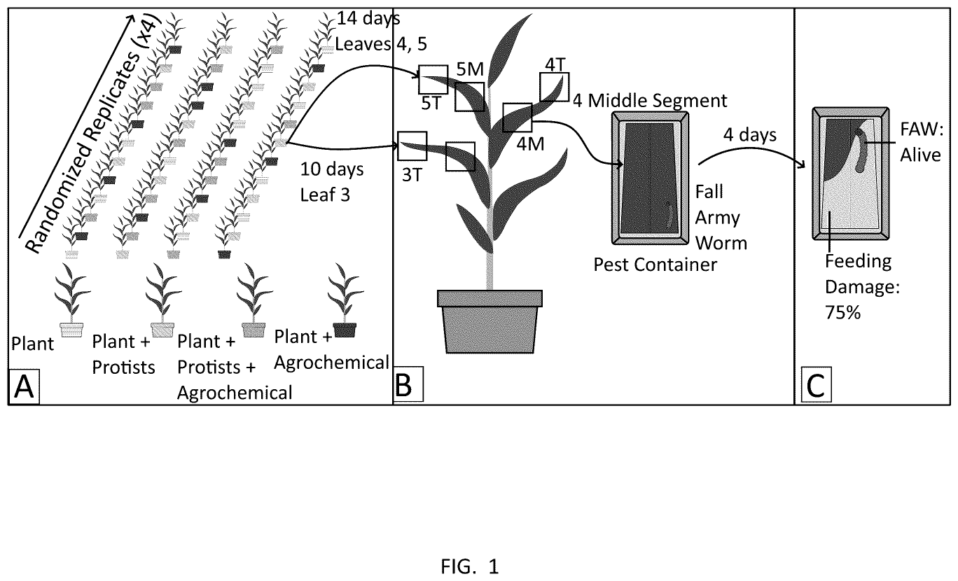

For each experimental run, 240 pots (10-cm, TLC Square Form Pots, HC Companies) were first filled with dry, steam pasteurized screened field soil (Kalamazoo, Michigan; Coloma loamy sand). The soil was misted with water with an automated system to reach field capacity in the Corteva Agriscience greenhouse located in Indianapolis, IN for at least 4 d prior to planting. Next, 3.8 cm deep, 2 cm wide holes were created in the center of each soil-filled pots, and a single seed was placed tip cap side down 3.8 cm below the soil surface. Each seed was immediately inoculated with a seed treatment (described above, n=60 per treatment). Treated pots were then randomized in the greenhouse to reduce systematic error (FIG. 1A). The greenhouse averaged 23° C. (maximum of 30° C. day and minimum of 19° C. at night). The plants received 100 mL water from the automated system, split over 49 passes, during the first week after planting, and 200 mL water split over 98 passes during the second week after planting.

### Example 6: Effects of Soil Protists on Pest Damage Resistance-Leaf Harvest

Leaf segments were harvested on 48 representative plants selected from the 60 pots per treatment (FIG. 1A). Trays were filled in a semi-random fashion with less optimal plants at the end of tray 3 and the most underdeveloped plants being discarded. Plants were numbered as they were selected during the Leaf 3 harvest, and tracked through the harvest of Leaves 4 and 5 for robustness. Maize leaves are labelled according to the order they sprout. Maize was allowed to grow for 10 d before harvesting Leaf 3 and left for another 4 d (14 d total) before harvesting Leave 4, 5 (FIG. 1B). Leaves were segmented with the distal 3.8 cm labelled as Tip. Leaf Middle segments were harvested as a 3.8-cm segment from the middle of the leaf. For smaller leaves (such as the earlier-harvested Leaf 3), the Middle abutted the Tip. For larger leaves (4th and 5th), any section between Tip and Middle segments was discarded. For agrochemicals which translocate, such as those tested here, the agrochemical accumulates in the leaf Tips. By testing both leaf Tip and Middle, the relative amount of agrochemical moved by phloem or xylem transport since the leaf sprouted can be measured (Tip) along with the agrochemical in the process of transportation during harvest (Middle).

### Example 7: Effects of Soil Protists on Pest Damage Resistance-Pest Stage Setup

Sections of maize leaves were placed in containers (3×6×2.5 cm deep) prepared with 5 mL of cooled 0.8% water agar to keep the container humidified along with a second instar Spodoptera frugiperda. Containers were sealed and placed in a dark chamber at 25° C. After 4 d the containers were removed, and the contents evaluated. Leaf segments were graded based on feeding damage (e.g., 100% damage means no leaf remaining), while the FAW were evaluated for mortality (FIG. 1C). Dead or dying FAW were both recorded as dead.

### Example 8: Effects of Soil Protists on Pest Damage Resistance-Pest Stage Analysis

Out of the anticipated 960 plants×6 leaf segments per plant=5760 assay wells, 49 individual wells were found to contain a FAW larvae that was dead upon infestation or the well contained no larvae. These observations are dropped resulting in 5711 total observations in the data set.

Feeding damage to each plant from the pest stage was compared across treatments according to three levels of granularity: overall feeding damage, feeding damage grouped by leaf (feeding damage separated into Leaf 3, Leaf 4, and Leaf 5), and by leaf segment (feeding damage separated into Leaf 3 Tip, Leaf 3 Middle, Leaf 4 Tip, Leaf 4 Middle, Leaf 5 Tip, and Leaf 5 Middle). Statistical significance was determined using pairwise t-tests with Bonferroni adjustment for the multiple hypothesis tests. To control for possible confounds of experimental run or tray number, feeding damage was regressed on treatment dummies as well as dummy variables for experimental run and tray location for overall feeding damage, FAW mortality rate, and feeding damage individually for each leaf segment (Tables 4-7). Tray number was significant due to selection method-tray 3 contained any less developed plants needed to fill the 48-plant total. All statistical analysis, including regressions and t-tests, were performed using Stata 17.0. Raw data and Stata code are available as supplemental materials.

TABLE 4
Regression for overall feeding damage (averaged across
six leaf segment measures for each plant) with controls
for experimental run and tray location

| | |
|---|---|
| Protists | 0.948 |
| | (1.21) |
| Chlorantraniliprole | −31.836*** |
| | (1.643) |
| Spinosad | −39.981*** |
| | (2.56) |
| Chlorantraniliprole + Protists | −41.376*** |
| | (1.775) |
| Spinosad + Protists | −60.922*** |
| | (2.255) |
| Run 2 | 1.656 |
| | (1.565) |
| Run 3 | −3.464* |
| | (1.516) |
| Run 4 | −11.971*** |
| | (1.719) |
| Run 5 | 8.721*** |
| | (2.027) |
| Tray 2 | −0.034 |
| | (1.262) |
| Tray 3 | 3.446** |
| | (1.254) |
| Constant | 93.524*** |
| | (1.562) |
| Observations | 960 |
| R² | 0.695 |

Treatment Baseline, Run 1, and Tray 1 are the omitted reference categories.
Robust standard errors are in parentheses.
***p < 0.001,
**p < 0.010,
*p < 0.050

TABLE 5
Regression for FAW mortality rate (across six leaf segments for
each plant) with controls for experimental run and tray location

| | |
|---|---|
| Protists | −0.937 |
| | (1.304) |
| Chlorantraniliprole | 20.341*** |
| | (1.685) |
| Spinosad | 33.342*** |
| | (2.642) |
| Chlorantraniliprole + Protists | 29.994*** |
| | (1.948) |
| Spinosad + Protists | 53.915*** |
| | (3.053) |
| Run 2 | −2.969 |
| | (1.665) |
| Run 3 | −2.552 |
| | (1.578) |
| Run 4 | 10.752*** |
| | (1.963) |
| Run 5 | −15.029*** |
| | (2.229) |
| Tray 2 | −0.042 |
| | (1.444) |
| Tray 3 | −2.833* |
| Constant | (1.398) |
| | 5.605*** |
| | (1.634) |
| Observations | 960 |
| R² | 0.567 |

Treatment Baseline, Run 1, and Tray 1 are the omitted reference categories.
Robust standard errors are in parentheses.
***p < 0.001,
**p < 0.01,
*p < 0.050

TABLE 6
Regression for feeding damage by leaf segment in Baseline, Protists, Chlorantraniliprole, and
Chlorantraniliprole + Protists treatments with controls for experimental run and tray location

| | (1) | (2) | (3) | (4) | (5) | (6) |
|---|---|---|---|---|---|---|
| | Leaf 3 | Leaf 3 | Leaf 4 | Leaf 4 | Leaf 5 | Leaf 5 |
| | Middle | Tip | Middle | Tip | Middle | Tip |
| Protists | 0.015 | 0.349 | 0.401 | 1.204 | −0.760 | 1.645 |
| | (1.398) | (1.398) | (1.528) | (1.811) | (1.191) | (1.056) |
| Chlorantraniliprole | −36.100*** | −65.841*** | −6.424** | −46.026*** | −2.566 | −34.783*** |
| | (2.972) | (2.787) | (2.124) | (3.095) | (1.500) | (2.978) |
| Chlorantraniliprole + | −34.183*** | −72.920*** | −27.549*** | −56.463*** | −26.343*** | −33.057*** |
| Protists | (3.066) | (2.423) | (2.749) | (3.209) | (2.390) | (2.964) |
| Run 2 | −1.161 | 9.866*** | −6.856** | −13.021*** | 10.990*** | 11.382*** |
| | (2.857) | (2.349) | (2.347) | (3.117) | (2.096) | (2.556) |
| Run 3 | −4.312 | 6.557** | −16.964*** | −18.266*** | 6.949*** | 5.711* |
| | (2.721) | (2.291) | (2.230) | (2.914) | (1.883) | (2.671) |
| Run 4 | −11.027*** | 2.812 | −15.203*** | −10.762*** | 3.068 | 6.359*** |
| | (2.701) | (2.448) | (2.300) | (2.806) | (1.801) | (1.889) |
| Run 5 | 2.198 | 8.781*** | −5.201 | −10.429** | 12.817*** | 6.683** |
| | (2.158) | (1.860) | (2.710) | (3.181) | (2.121) | (2.295) |
| Tray 2 | 0.087 | 1.125 | 1.984 | −2.984 | 4.756** | −0.003 |
| | (2.088) | (1.649) | (1.957) | (2.246) | (1.493) | (2.067) |
| Tray 3 | 3.980 | 6.648*** | 6.400*** | 6.053** | 2.856 | 3.101 |
| | (2.151) | (1.942) | (1.795) | (2.290) | (1.556) | (1.962) |
| Constant | 96.201*** | 88.194*** | 97.958*** | 103.981*** | 82.277 | 89.305*** |
| | (2.487) | (2.272) | (2.290) | (2.935) | (1.720) | (2.432) |
| Observations | 761 | 761 | 762 | 763 | 757 | 757 |
| R² | 0.347 | 0.734 | 0.271 | 0.519 | 0.321 | 0.381 |

Treatment Baseline, Run 1, and Tray 1 are the omitted reference categories.
Robust standard errors are in parentheses.
***p < 0.001,
**p < 0.010,
*p < 0.050

TABLE 7
Regression for feeding damage by leaf segment in Baseline, Protists, Spinosad, and
Spinosad + Protists treatments with controls for experimental run and tray location

| | (1) | (2) | (3) | (4) | (5) | (6) |
|---|---|---|---|---|---|---|
| | Leaf 3 | Leaf 3 | Leaf 4 | Leaf 4 | Leaf 5 | Leaf 5 |
| | Middle | Tip | Middle | Tip | Middle | Tip |
| Protists | −0.132 | 0.188 | 0.420 | 1.228 | −0.803 | 1.890 |
| | (1.497) | (1.438) | (1.487) | (1.676) | (1.245) | (1.266) |
| Spinosad | −45.225*** | −59.140*** | −40.880*** | −59.365*** | −10.627*** | −29.736*** |
| | (3.180) | (3.558) | (3.443) | (3.568) | (2.739) | (3.696) |
| Spinosad + | −70.136*** | −83.885*** | −61.130*** | −76.709*** | −32.450*** | −47.455*** |
| Protists | (2.807) | (2.263) | (2.994) | (2.866) | (3.435) | (3.717) |
| Run 2 | 1.656 | 3.635 | −1.561 | −0.198 | 3.756 | 5.361*** |
| | (2.859) | (2.581) | (2.572) | (3.099) | (2.100) | (1.594) |
| Run 3 | 4.187 | 3.667 | −4.323 | 4.873 | 2.421 | 3.865 |
| | (2.377) | (2.570) | (2.366) | (2.587) | (1.508) | (2.001) |
| Run 4 | −17.522*** | −8.321** | −11.335*** | −3.336 | −8.054*** | −8.989*** |
| | (2.887) | (2.718) | (2.555) | (2.843) | (1.895) | (2.320) |
| Run 5 | 16.662*** | 14.237*** | 2.848 | 6.065* | 16.057*** | 16.246*** |
| | (2.661) | (2.493) | (2.762) | (3.051) | (2.054) | (2.449) |
| Tray 2 | −1.617 | 0.012 | −0.394 | 0.056 | 1.138 | −1.812 |
| | (1.798) | (1.834) | (1.984) | (2.095) | (1.833) | (2.111) |
| Tray 3 | −0.453 | −1.671 | 0.677 | 1.033 | −1.162 | 0.627 |
| | (1.917) | (1.885) | (1.858) | (1.957) | (1.724) | (1.869) |
| Constant | 94.548*** | 94.459*** | 94.685*** | 92.669*** | 88.790*** | 93.210*** |
| | (2.463) | (2.511) | (2.430) | (2.831) | (1.543) | (2.211) |
| Observations | 664 | 666 | 666 | 669 | 666 | 664 |
| R² | 0.712 | 0.758 | 0.618 | 0.697 | 0.378 | 0.496 |

Treatment Baseline, Run 1, and Tray 1 are the omitted reference categories.
Robust standard errors are in parentheses.
***p < 0.001,
**p < 0.010,
*p < 0.050

### Example 9: Effects of Soil Protists on Pest Damage Resistance-Overall Feeding Damage

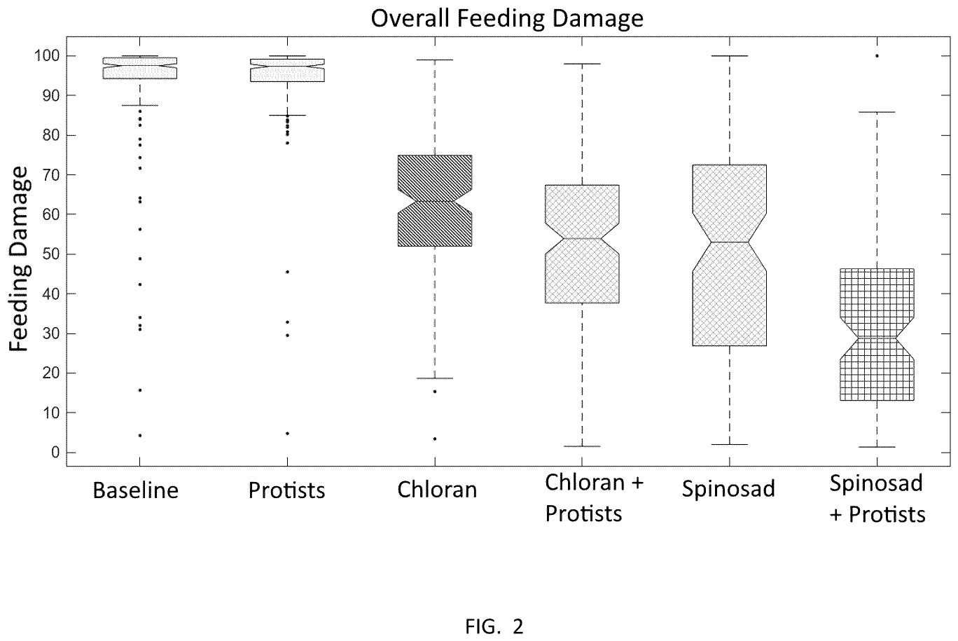

Overall feeding damage was computed by averaging, for each plant, the damage measures for each of the six leaf segments. Results by treatment are plotted in FIG. 2 with different colors within each panel reflecting significant differences in means (p<0.001). No significant difference in mean overall feeding damage was found between Baseline and Protists treatments (94% vs. 95% feeding damage, p >0.10). Both the Chlorantraniliprole treatment and the Spinosad treatment exhibited significantly less mean overall feeding damage (62% and 53%, respectively) than either Baseline or Protists treatments (p<0.001). Co-application of protists along with each agrochemical further reduced feeding damage (p<0.001). Mean overall feeding damage was 53% in Chlorantraniliprole+Protists and 32% in Spinosad+Protists.

Data for Baseline and Protists were pooled across all 5 experimental runs while the remaining are only available within subsets of the runs (experimental runs 1, 2, 3 for Chlorantraniliprole; runs 4, 5 for Spinosad). Statically similar results were obtained when restricting Baseline and Protists data pools to similar subsets (Runs 1, 2, 3 or Runs 4, 5). The regressions confirmed the above results: no significant difference between Baseline and Protists (p=0.433), and highly significant differences (all p<0.001) between Baseline and either agrochemical, Protists and either agrochemical, and between each agrochemical with and without Protists. Further robustness tests involved using average FAW mortality across the six measurements for each plant instead of damage as the independent variable (Table 5). Again, no significant difference between Baseline and Protists was observed (p=0.472) and highly significant differences (all p<0.001) for other treatment comparisons.

These experiments demonstrated that an agrochemical such as Chlorantraniliprole+Protists led to about 44% less feeding damage than Baseline or Protists and about 15% less feeding damage than Chlorantraniliprole alone (about 62% to 53%). Agrochemicals such as Spinosad+Protists led to about 66% less feeding damage than Baseline or Protists and 40% less feeding damage than Spinosad alone (about 53% to 32%). These reductions are all highly statistically significant (p<0.001).

### Example 10: Effects of Soil Protists on Pest Damage Resistance-Chlorantraniliprole by Leaf Segment

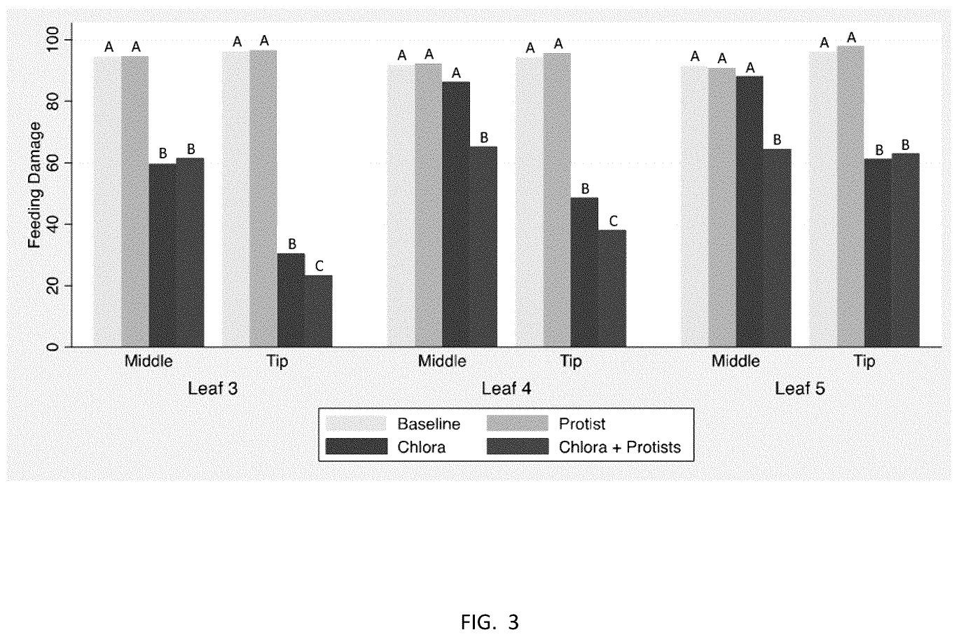

Treatment with Chlorantraniliprole was analyzed based on how different leaf segments were protected from herbivory. Feeding damage for each leaf segment for Chlorantraniliprole with and without protists are shown in FIG. 3, with Baseline and Protists treatments included for comparison. In all cases, the Chlorantraniliprole+Protists treatment had significantly less feeding damage than either Baseline or Protist treatments (p<0.001). The effect of Chlorantraniliprole without protists varied by leaf number with early leaves being better protected than later leaves. Chlorantraniliprole significantly reduced feeding damage relative to Baseline and Protist treatments (p<0.001) in both segments of Leaf 3 and in Leaf 4 Tip and Leaf 5 Tip with the remaining two segments (Leaf 4 Middle, Leaf 5 Middle) showing no or only marginal significant reductions (p≥0.050). Significant differences between Chlorantraniliprole and Chlorantraniliprole+Protists treatments were again observed in Leaf 4 Tip (p=0.008), Leaf 4 Middle (p<0.001), and Leaf 5 Middle (p<0.001), but were also observed in Leaf 3 Tip (p=0.030).

Comparing feeding damage between Chlorantraniliprole and Chlorantraniliprole+Protists treatments, the results again varied by leaf number. Chlorantraniliprole+Protists significantly reduced feeding damage relative to Chlorantraniliprole for Leaf 4 Tip (49% vs. 38%, p=0.013), Leaf 4 Middle (86% vs. 65%, p<0.001), and Leaf 5 Middle (88% vs. 64%, p<0.001). The co-application of protists to Chlorantraniliprole was not additionally protective (p >0.050) for either segment of Leaf 3 or for Leaf 5 Tip. Importantly, in both segments where Chlorantraniliprole alone did not significantly reduce feeding damage (Leaf 4 Middle and Leaf 5 Middle), the co-application of protists significantly reduced feeding damage.

Leaf 4 Middle and Leaf 5 Middle show the largest difference in feeding damage reduction between Chlorantraniliprole and Chlorantraniliprole+Protists. For Leaf 4 Middle, Chlorantraniliprole reduces damage relative to Baseline from 93.6% to 86.4%, a 7.2 percentage point reduction. Chlorantraniliprole+Protists reduces damage to 65.2%, a reduction of 28.4 percentage points from Baseline, or nearly 4 times the benefit of Chlorantraniliprole alone. Similarly, Leaf 5 Middle sees damage reduction of 3.5 percentage points from Chlorantraniliprole relative to baseline while Chlorantraniliprole+Protists reduces damage by 27.2 percentage points, or more than 7 times the benefit of Chlorantraniliprole alone.

### Example 11: Effects of Soil Protists on Pest Damage Resistance-Spinosad by Leaf Segment

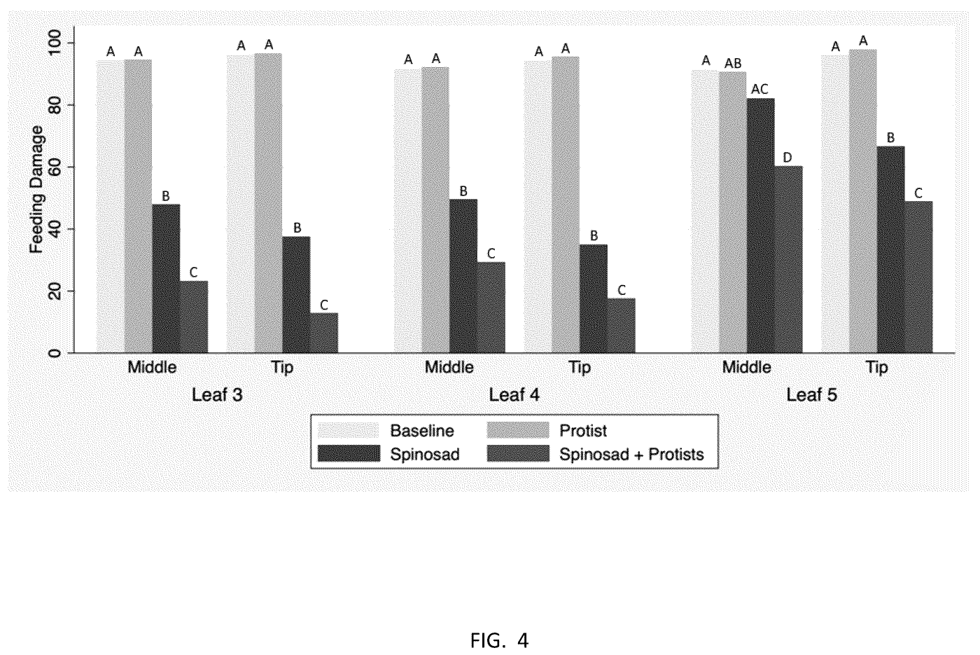

For the Spinosad treatments, feeding damage by leaf segment displayed the same trends as overall feeding damage (all feeding damage grouped by plant), with some slight differences (FIG. 4). In almost all cases, Spinosad showed highly significantly lower feeding damage than either Baseline or Protists (p<0.001 pairwise t-tests with Bonferroni adjustment for multiple hypothesis tests) except for Leaf 5 Middle which exhibited lower significance (p=0.014 relative to Protists, p=0.053 relative to Baseline). Unlike Chlorantraniliprole, however, there is a statistically significant difference between Spinosad alone and Spinosad+Protists for each leaf segment (p<0.001).

Because Spinosad was more effective than Chlorantraniliprole in reducing damage even without co-application of protists, the relative effect of adding protists is less dramatic with Spinosad than with Chlorantraniliprole. Leaf 4 Tip saw the lowest feeding damage from Spinosad alone, reducing feeding damage by 58.5 percentage points relative to Baseline (about 93.5% vs. 35.0%). Spinosad+Protists resulted in a 75.8 percentage point reduction (to about 17.7%), or about 30% improvement in feeding reduction over Spinosad alone. For Leaf 5 Middle, where Spinosad alone was least effective, Spinosad reduced feeding damage relative to Baseline by 9.5 percentage points (about 91.6% vs. 82.2%) while Spinosad+Protists resulted in more than three times the reduction, about 31.2 percentage points (to 60.3).

### Example 12: Effects of Soil Protists on Pest Damage Resistance-Protist Benefit

To isolate the effects of co-application of soil protists with each agrochemical, each agrochemical treatment was compared with its respective agrochemical+protists treatment in a regression framework controlling for leaf and leaf section (Table 8). In columns (1) and (2), the dependent variable is log of feeding damage, so that coefficients can be interpreted as the percentage change in damage.

TABLE 8
Regressions of logged feeding damage and mortality on leaf
sections and the co-application of protists. Columns (1)
and (3) use data from the Chlorantraniliprole and Chlorantraniliprole
+ Protists treatments. Columns (2) and (4) use data
from the Spinosad and Spinosad + Protists treatments.

| | (1) | (2) | (3) | (4) |
|---|---|---|---|---|
| | Log(damage) OLS | | Mortality (logistic) | |
| | Chloran- | | Chloran- | |
| | traniliprole | Spinosad | traniliprole | Spinosad |
| Protist | −0.303*** | −0.772* | 0.594*** | 0.984*** |
| co-application | (0.073) | (0.131) | (0.138) | (0.227) |
| Middle | 0.847*** | 0.530*** | −1.925*** | −0.852*** |
| Section | (0.042) | (0.045) | (0.123) | (0.094) |
| Leaf 4 | 0.414*** | 0.432*** | −0.845*** | −0.635*** |
| | (0.055) | (0.079) | (0.123) | (0.115) |
| Leaf 5 | 0.751*** | 1.236*** | −0.968*** | −1.798*** |
| | (0.059) | (0.081) | (0.164) | (0.154) |
| Constant | 2.961*** | 2.636*** | 0.073 | 0.545** |
| | (0.069) | (0.120) | (0.132) | (0.192) |
| Observations | 1716 | 1150 | 1716 | 1150 |
| R²/Pseudo R² | 0.212 | 0.250 | 0.159 | 0.138 |

Leaf 3 and Tip section are the omitted reference categories.
Robust standard errors clustered by plant are in parentheses.
P-values for F test and Wald chi-squared test for regression and logit, respectively, are p < 0.001.
***p < 0.001,
**p < 0.010,
*p < 0.050

Again, higher feeding damage was observed in later leaves, with Leaf 5 exhibiting higher damage than Leaf 4, and Leaf 4 exhibiting higher damage than Leaf 3, the reference category. Higher damage in the Middle sections of leaves was also observed than in the Tip sections. However, in aggregate, significant reduction of feeding damage was observed due to co-application of protists for each agrochemical, reducing feeding damage by 30% when co-applied with Chlorantraniliprole than when Chlorantraniliprole is applied alone, and reducing feeding damage by 77% when co-applied with Spinosad. These reductions are highly statistically significant (p<0.001). Columns (3) and (4) of Table 8 serve as a robustness check by using FAW mortality as the dependent variable in a logistic regression. The same results are observed, with coefficients flipped in sign since FAW mortality is associated with lower feeding damage.

Based on the feeding damage data gathered from the experiments described here, it was concluded that the addition of Protists to a seed treatment with Chlorantraniliprole or Spinosad can improve both the protection provided by, and the duration for which the agrochemical offers protection to the plant. This is best demonstrated by the middle sections of Leaf 5—the last leaf to emerge. For both agrochemicals tested—Chlorantraniliprole and Spinosad—the addition of Protists to the agrochemical offered increased protection against pests (reduction in feeding damage) compared with the agrochemical alone. Chlorantraniliprole offers a particularly interesting case—the Chlorantraniliprole alone does not offer any statistically significant protection by the Middle segment of Leaf 5, while co-inoculation of Chlorantraniliprole+Protists increases the amount of protection offered (decreased feeding damage) when compared with Chlorantraniliprole alone, extending the protection into leaf segments that are outside the zone of protection of Chlorantraniliprole alone. It is worth noting that testing was performed in pasteurized soil for consistency.

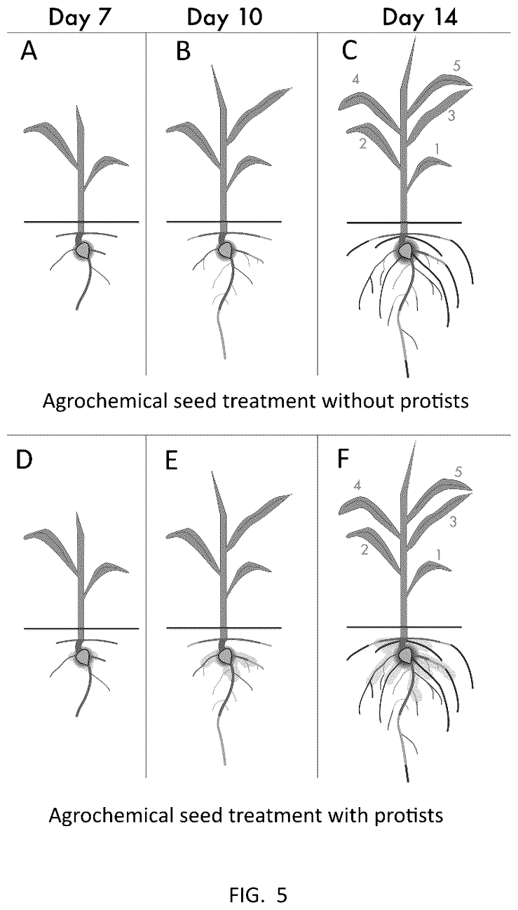

Inventors demonstrated that protists actively transporting agrochemicals throughout the root network is the method by which Protists enhance the protection offered by the agrochemicals tested here. Leaf number should correlate with root network size, i.e., the root network was smaller when the earliest leaf tested (Leaf 3) was formed compared to its size when the last leaf (Leaf 5) was formed (FIG. 5). Looking at the results for these leaves, the addition of protists to a seed treatment containing agrochemical did not seem to confer significant benefits for Leaf 3 which developed with the smallest average root network and with the longest time to accumulate agrochemical. However, leaves with larger average root network size, such as Leaves 4 and 5, did show statistically significant benefits from the co-inoculation of Protists with the agrochemical compared with the agrochemical alone. This evidence combined with previous research on protist-based transportation, inventors can conclude that Protists can transport the agrochemicals tested. Additionally, testing of additional leaves (e.g., Leaf 6, 7, or 8) may show a similar break where Spinosad alone offers no protection to the leaves while co-inoculation of Spinosad+Protists continues to protect from feeding damage.

Other benefits of inoculation with soil protists may include re-establishing protists depleted by fertilization, regulating bacterial communities by top-down selective grazing, and modulating soil fertility. In an embodiment, the transport payloads can be micro- and nano-particles. As some agrochemicals are already milled to the micron range as part of their commercial formulations, this would not be a limiting factor. Seed applied agrochemicals are often chosen due to their high specific activity (low required therapeutic dosage), long term soil retention/treatment duration, and high cost. When combined with a targeted transport technology, regular seed treatment could offer improved efficacy relative to seed treatment alone due to the expansion of the therapeutic zone to include more of the growing roots. The agrochemical composition described here provides a potential straightforward method to boost the performance of agrochemicals, enabling the use of new classes of agrochemicals as seed treatments, or reduction of the quantity required for seed treatments. This can provide economic benefits, and offer additional tools to combat the growing resistance of pests.

### Example 13: Effects of Soil Protists on Pest Damage Resistance—¹⁴C Experiments

A scaled-up version of the μ-rhizoslide was developed to work with maize. First, ¹⁴C-labeled agrochemical was dissolved in acetone, spiked onto the wall of a glass sample vial, and the acetone evaporated. Un-radiolabeled agrochemical formulation was then added to the vial and sonicated for 20 min to distribute the ¹⁴C-labeled material into the formulation. The formulation was then mixed with Page's Saline containing heat-killed E. coli, or with Page's Saline containing both protists and heat-killed E. coli to prepare the seed treatments formulation. As described before, the ¹⁴C-labeled seed treatment formulations were allowed to rest in darkness for 24 h prior to application. Final radioactivity was measured at approximately 300,000 DPM per individual seed treatment. Pots were filled, and seeds planted and treated as described above. Plants were harvested at 1 week due to restricted space for work with radiolabeled material. Once harvested, stem and leaves (stem segment) were separated from the roots and soil (root segment). Stem segments were freeze dried, then exposed on plates (20×25 mm Exposure cassette, Cytivia) for 24 h before being imaged by autoradiography (GE Amersham Molecular Dynamics Typhoon 9410 Molecular Imager). Plate images were processed using Image Quant TL software. The root segments had the seed remnants removed from the roots to prevent over-exposure on the plate due to being the location of initial dosing. Root segments then followed the same procedure as the stem portion of the plant. Plates for all treatments were imaged simultaneously to improve consistency within each experiment.

### Example 14: Effects of Soil Protists on Pest Damage Resistance-Transport of ¹⁴C-Labeled Chlorantraniliprole

A similar experiment was conducted using ¹⁴C-labeled Chlorantraniliprole, differing in the allocated growth period (7 vs 14 d), watering schedule (due to limitations of radioactive containment), and pot (3D printed device optimized for radio-detection vs traditional 4.5″ pot). Radioactivity in both the plant material and the soil were measured before combustion analysis was conducted on the plant material.

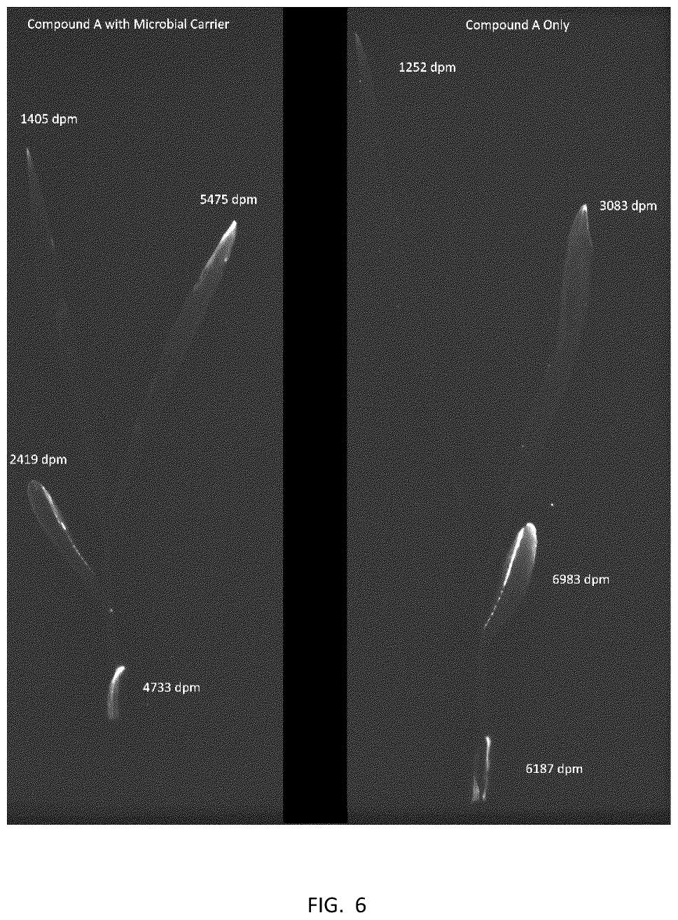

¹⁴C results appear to show differing distribution of Chlorantraniliprole in the presence of protists when compared with the absence of protists, FIG. 6. From these results, a general trend of higher concentration of Chlorantraniliprole in earlier parts (stem, Leaf 1) for Chlorantraniliprole alone when compared with Chlorantraniliprole and protists, and the reverse in later parts (Leaf 2, Leaf 3) appears to attain.

It should also be understood that, in certain methods described herein that include more than one step or act, the order of the steps or acts of the method is not necessarily limited to the order in which the steps or acts of the method are recited unless the context indicates otherwise. Furthermore, the terms first, second, etc., as used herein are not meant to denote any particular ordering, but simply for convenience to denote a plurality of, for example, layers.

Embodiments disclosed here are not limiting of the subject matter and is merely exemplary. Various other components may be included and called upon for providing for aspects of the teachings herein. For example, additional materials, combinations of materials and/or omission of materials may be used to provide for added embodiments that are within the scope of the teachings herein.

Furthermore, the disclosure encompasses all variations, combinations, and permutations in which one or more limitations, elements, clauses, and descriptive terms from one or more of the listed claims are introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group.

All compounds are understood to include all possible isotopes of atoms occurring in the compounds. Isotopes include those atoms having the same atomic number but different mass numbers and encompass heavy isotopes and radioactive isotopes. By way of general example, and without limitation, isotopes of hydrogen include tritium and deuterium, and isotopes of carbon include ¹¹C, ¹³C, and ¹⁴C. Accordingly, the compounds disclosed herein may include heavy or radioactive isotopes in the structure of the compounds or as substituents attached thereto. Examples of useful heavy or radioactive isotopes include ¹⁸F, ¹⁵N, ¹⁸O, ⁷⁶Br, ¹²⁵I and ¹³¹I.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

All U.S. and PCT patent publications and U.S. patents mentioned herein are hereby incorporated by reference in their entirety as if each individual patent publication or patent was specifically and individually indicated to be incorporated by reference. In case of conflict, the present application, including any definitions herein, will control.

What is claimed is:

1. An agrochemical composition, comprising:
i. an agriculturally suitable carrier;
ii. at least one encysted or sporulated protozoa (protist); and
iii. an agricultural payload, comprising an agrochemical.

2. The agrochemical composition of claim 1, wherein the agrochemical comprises one or more of an insecticide, a nematicide, and a fungicide, each, if present, with a water solubility of less than about 50 ppm and log K_{ow} higher than about 2.5.

3. The agrochemical composition of claim 1, further comprising a food source for the protist.

4. The agrochemical composition of claim 3, wherein the food source is bacteria.

5. The agrochemical composition of claim 1, wherein the agriculturally suitable carrier comprises a seed-based carrier or comprises a non-seed-based carrier.

6. The agrochemical composition of claim 5, wherein the seed-based carrier comprises a plant seed coated with an encysted or sporulated protist and agricultural payload, and the non-seed-based carrier comprises a granular carrier, a liquid slurry carrier, a liquid suspension carrier, or a combination thereof.

7. The agrochemical composition of claim 1, wherein the soil protist is a phagotrophic soil protist.

8. The agrochemical composition of claim 7, wherein the at least one soil protist is selected from the group consisting of Colpoda sp., Amoeba sp., flagellates, ciliates, cercozoans, rhizaria, testate amoebae, heliozoan, and euglenoids.

9. The agrochemical composition of claim 1, wherein the agrochemical comprises an insecticide.

10. The agrochemical composition of claim 1, wherein the agrochemical comprises a nematicide.

11. The agrochemical composition of claim 1, wherein the agrochemical comprises a fungicide.

12. The agrochemical composition of claim 9, wherein the insecticide comprises chlorantraniliprole or cyantraniliprole.

13. The agrochemical composition of claim 9, wherein the insecticide is chlorantraniliprole or Spinosad, or a combination thereof.

14. A modified plant seed, comprising:
i. a plant seed selected from the group consisting of alfalfa, almonds, apples, barley, beans, canola, corn, cotton, crucifers, flowers, fodder species, fruits, lettuce, oats, oil seed crops, oranges, peanuts, pears, peppers, potatoes, rice, sorghum, soybeans, strawberries, sugarcane, sugar beets, sunflowers, tobacco, tomatoes, and wheat; and
ii. the agrochemical composition of claim 1,
wherein the composition is coated on at least part of the plant seed.

15. A method for treating a plant seed, comprising coating at least part of a plant seed with the agrochemical composition of claim 1.

16. A method, comprising administering the composition of claim 1 to soil with an existing seed or plant, to soil where a plant or seed is to be planted, or to a seed or plant prior to planting, wherein the method reduces plant loss to pests.

17. The method of claim 16, wherein the pest is selected from Phyla Arthropoda, Mollusca, or Nematoda 12.

18. A method, comprising the step of applying the agrochemical composition of claim 1 to a medium where a crop plant is growing, to a seed or to a seed coating, wherein the method controls or eliminates a pest infestation of the crop plant.

19. The method of claim 18, wherein the medium where the crop plant is growing is soil.

20. A method for improved plant growth, comprising administering the composition of claim 1 to soil with an existing seed or plant, to soil where a plant or seed is to be planted, or to a seed or plant prior to planting.
